(19) United States
(12) Patent Application Publication
(10) Pub. No.: US 2025/0234097 A1
(43) Pub. Date: Jul. 17, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: KOHEI IWABUCHI, Kanagawa (JP); KOJI FUSE, Tokyo (JP)

(21) Appl. No.: 18/981,942

(22) Filed: Dec. 16, 2024

(30) Foreign Application Priority Data
Jan. 17, 2024 (JP) 2024-005558

(51) Int. Cl. H04N 23/74; G06T 7/00; G06T 7/40; G06T 7/90; H05B 47/16

(52) U.S. Cl. CPC H04N 23/74; G06T 7/0002; G06T 7/40; G06T 7/90; H05B 47/16; G06T 2207/10024; G06T 2207/10152; G06T 2207/30168

(57) ABSTRACT

There is provided with an information processing apparatus. An outputting unit outputs an image capture instruction signal instructing that image capturing is performed, to an image capture apparatus. An obtaining unit obtains an image capture timing signal indicating a timing for performing image capturing, from the image capture apparatus. A control unit performs lighting control of a light source in accordance with the image capture timing signal being obtained.

### BACKGROUND OF THE INVENTION

### Field of the Invention

The present invention relates to an information processing apparatus, an information processing method, and a storage medium.

### Description of the Related Art

There are known techniques for obtaining a plurality of captured images in which the illumination direction differs, by capturing images of a target object while individually turning on a plurality of light sources that form a multi-light illumination device. Japanese Patent Laid-Open No. 2015-232480 discloses a technique for turning on a light source and capturing an image of a target object based on a common trigger signal, in order to align a lighting timing of the light source with an image capture timing.

### SUMMARY OF THE INVENTION

According to one embodiment of the present invention, an information processing apparatus comprises: an outputting unit configured to output an image capture instruction signal instructing that image capturing is performed, to an image capture apparatus; an obtaining unit configured to obtain an image capture timing signal indicating a timing for performing image capturing, from the image capture apparatus; and a control unit configured to perform lighting control of a light source in accordance with the image capture timing signal being obtained.

According to one embodiment of the present invention, an information processing method comprises: outputting an image capture instruction signal instructing that image capturing is performed, to an image capture apparatus; obtaining an image capture timing signal indicating a timing for performing image capturing, from the image capture apparatus; and performing lighting control of a light source in accordance with the image capture timing signal being obtained.

According to one embodiment of the present invention, a non-transitory computer-readable storage medium stores a program which, when executed by a computer comprising a processor and memory, causes the computer to: output an image capture instruction signal instructing that image capturing is performed, to an image capture apparatus; obtain an image capture timing signal indicating a timing for performing image capturing, from the image capture apparatus; and perform lighting control of a light source in accordance with the image capture timing signal being obtained.

Further features of the present invention will become apparent from the following description of exemplary embodiments (with reference to the attached drawings).

### BRIEF DESCRIPTION OF THE DRAWINGS

FIGS. 1A to 1E are diagrams showing an exemplary configuration of an image processing system.

FIGS. 2A to 2C are diagrams for describing a circuit configuration of the image processing system.

FIG. 3 is a block diagram showing an exemplary functional configuration of the image processing system.

FIGS. 4A to 4C are flowcharts showing an example of information processing that is executed in the image processing system.

FIGS. 5A and 5B are diagrams for describing information processing that is performed in the image processing system.

FIGS. 6A to 6E are diagrams for describing an image capture system in a conventional example.

FIGS. 7A and 7B are a flowchart showing an example of information processing in a modification.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

In a case where an image capture apparatus in which a release time lag changes each time image capturing is performed is used, an image capture timing after trigger transmission changes each time image capturing is performed. On the other hand, a lighting timing of a light source after trigger transmission is consistent. For this reason, there have been cases where, when an image capture apparatus in which a release time lag changes each time image capturing is performed is used, a lighting timing of a light source is not aligned with an image capture timing.

Embodiments of the present invention provide an information processing apparatus that aligns a lighting timing of a light source with an image capture timing even when an image capture apparatus in which a release time lag changes each time image capturing is performed is used.

### Conventional Example

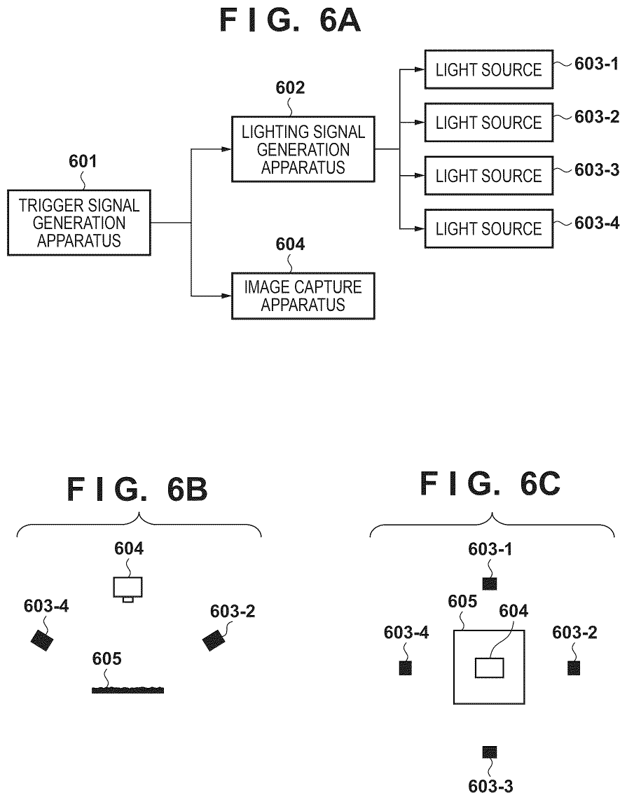

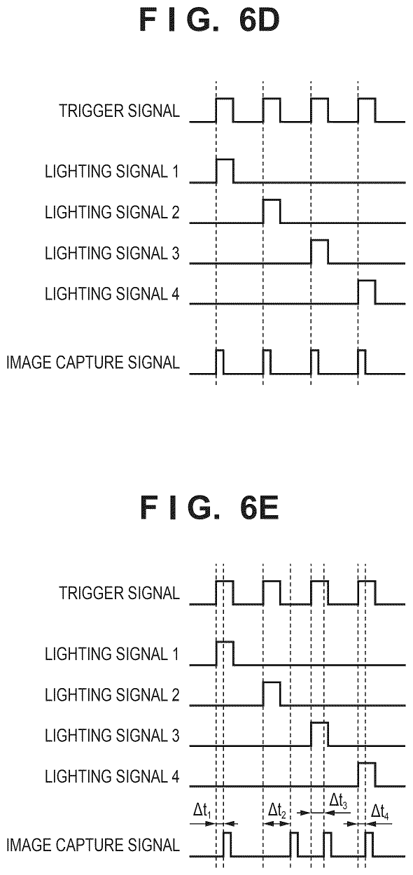

An image capture system in a conventional example will be described before describing an information processing apparatus according to an embodiment of the present invention. FIG. 6A is a block diagram showing a configuration of an image capture system in a conventional example. In the image capture system in the conventional example shown in FIG. 6A, lighting control of light sources 603-1 to 603-4 that is performed by a lighting signal generation apparatus 602 and image capture control that is performed by an image capture apparatus 604 are performed based on a common trigger signal transmitted from a trigger signal generation apparatus 601.

FIG. 6B is a side view showing the appearance of the image capture system in the conventional example. In addition, FIG. 6C is a top view showing the appearance of the image capture system in the conventional example. In this conventional example, four captured images in which the illumination direction differs are obtained by capturing images of the surface of a target object 605 while individually turning on the four light sources (603-1 to 603-4).

In the conventional example, in order to align lighting timings of the light sources with image capture timings, lighting of the light sources and image capturing of the target object are performed based on a common trigger signal. Specifically, first, the trigger signal generation apparatus 601 generates a trigger signal shown in FIG. 6D, and transmits the trigger signal to the lighting signal generation apparatus 602 and the image capture apparatus 604. This trigger signal consists of pulses in correspondence with the number of light sources (here, four). The lighting signal generation apparatus 602 generates lighting signals 1 to 4 shown in FIG. 6D based on the received trigger signal, and individually turns on the four light sources 603-1 to 603-4. The image capture apparatus 604 captures images of the surface of the target object 605, based on the received trigger signal. An image capture signal shown in FIG. 6D corresponds to an exposure period of the image capture apparatus 604.

In a case where an industrial camera in which no (an extremely small) release time lag occurs is used as the image capture apparatus 604, the timings at which the trigger signal rises coincide with the timings at which the respective image capture signals rise as shown in FIG. 6D. In addition, here, no delay occurs in the lighting signal generation apparatus 602, and timings at which the trigger signal rises coincide with the lighting timings of the respective light sources. For this reason, in a case where an industrial camera in which no (an extremely small) release time lag occurs is used as the image capture apparatus 604, the lighting timings of the light sources coincide with the image capture timings, respectively.

On the other hand, in many cases, industrial cameras are more expensive than consumer cameras in which a release time lag is assumed to be larger. In view of this, a case is envisioned in which a consumer camera is used as the image capture apparatus 604. Here, the consumer camera is a camera in which a release time lag of several tens of milliseconds occurs, and the release time lag changes each time image capturing is performed as indicated by “Δt1” and “Δt2” in FIG. 6E. That is to say, in the consumer camera described here, an image capture timing after trigger transmission changes each time image capturing is performed. On the other hand, also in this consumer camera, lighting timings of light sources after trigger transmission are constant. For this reason, there have been cases where, when an image capture apparatus in which a release time lag changes each time image capturing is performed, such as a consumer camera, is used, lighting timings of light sources are not aligned with image capture timings.

FIG. 6E is a diagram showing the lighting signals and the image capture signal in relation to the trigger signal in a case where such an image capture apparatus in which a release time lag changes each time image capturing is performed is used. In FIG. 6E, for example, in first image capturing and fourth image capturing, the exposure periods of the image capture apparatus are respectively included in the lighting periods of the light sources, and the lighting timings of the light sources are aligned with the image capture timings. On the other hand, in second image capturing, the exposure period of the image capture apparatus is not included in the lighting period of the light source. In this case, a completely dark image is obtained as a captured image. In addition, in third image capturing, a portion of the exposure period of the image capture apparatus is included in the lighting period of the light source, but the lighting period ends during the exposure period. In this case, an image that is captured is dark, compared with a case where a lighting timing of a light source is aligned with an image capture timing. On the other hand, according to the embodiment described below, even in a case where an image capture apparatus in which a release time lag changes each time image capturing is performed, such as a consumer camera, is used, lighting timings of light sources can be aligned with image capture timings. Hereinafter, a “consumer camera” refers to such an image capture apparatus in which a release time lag changes each time image capturing is performed, and an “industrial camera” refers to an image capture apparatus in which no (an extremely small) release time lag occurs.

### First Embodiment

### Hardware Configuration

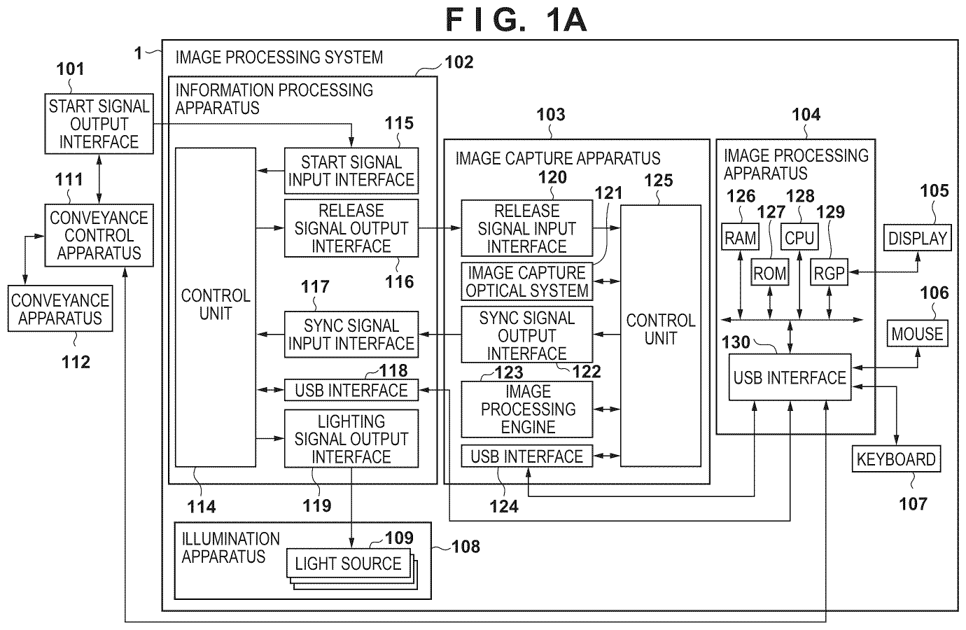

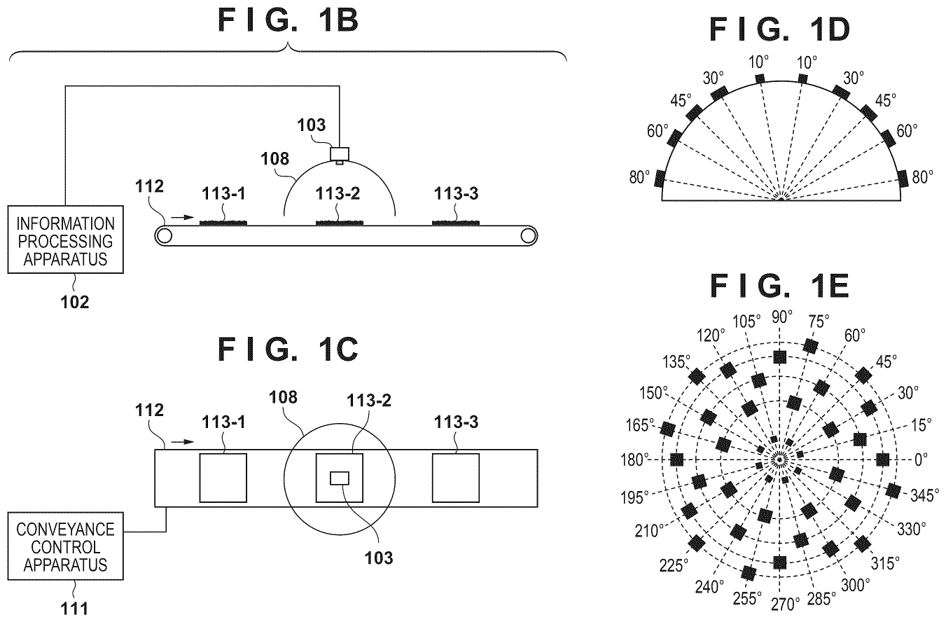

FIG. 1A is a block diagram showing an exemplary hardware configuration of an image processing system 1 that includes an information processing apparatus 102 according to the present embodiment. FIG. 1B is a side view showing the appearance of hardware of the image processing system 1. FIG. 1C is a top view showing the appearance of hardware of the image processing system 1.

The image processing system 1 according to the present embodiment includes the information processing apparatus 102, an image capture apparatus 103, an image processing apparatus 104, a display 105, a mouse 106, a keyboard 107, and an illumination apparatus 108. The image processing system 1 is communicably connected to a start signal output interface (start output I/F) 101 and a conveyance control apparatus 111.

The information processing apparatus 102 outputs an image capture instruction signal instructing image capturing, to the image capture apparatus 103, and obtains an image capture timing signal indicating a timing for performing image capturing from the image capture apparatus 103. In addition, in accordance with the image capture timing signal being obtained, the information processing apparatus 102 performs lighting control of at least one light source 109. The information processing apparatus 102 according to the present embodiment can control the illumination apparatus 108 to turn on a plurality of light sources 109 simultaneously or individually for a predetermined time in a predetermined order, and, at the same time, cause the image capture apparatus 103 to continuously capture images of a target object 113-2. Accordingly, the information processing apparatus 102 obtains a plurality of captured images in which the illumination direction differs.

At this time, the information processing apparatus 102 obtains, as the image capture timing signal, a sync signal that is output by the image capture apparatus 103 at an image capture timing, and turns on a light source 109 in accordance with the sync signal being obtained. By performing such processing, even in a case where an image capture apparatus in which a release time lag changes each time image capturing is performed is used as the image capture apparatus 103, lighting timings of light sources can be aligned with image capture timings. In addition, for example, the information processing apparatus 102 can stop output of a release signal based on the number of times the sync signal was obtained. In such a case, even if an image capture apparatus with which image capture timings during continuous image capturing are irregular is used as the image capture apparatus 103, continuous image capturing can be stopped when a predetermined number of images are captured.

### Hardware Configuration of Image Processing Apparatus

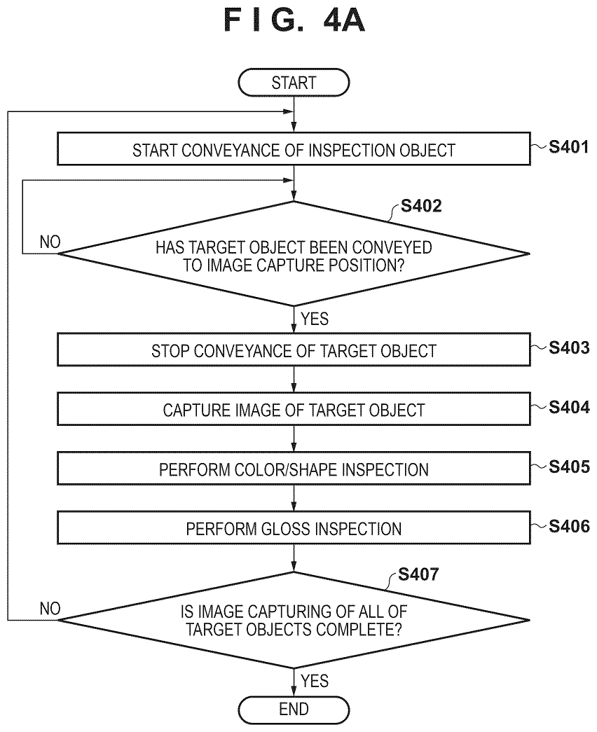

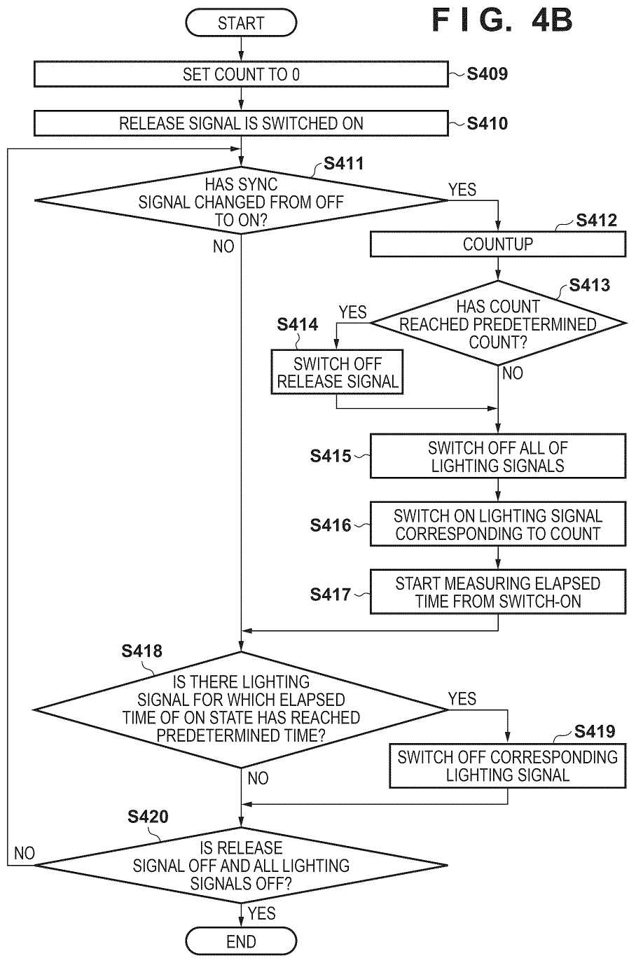

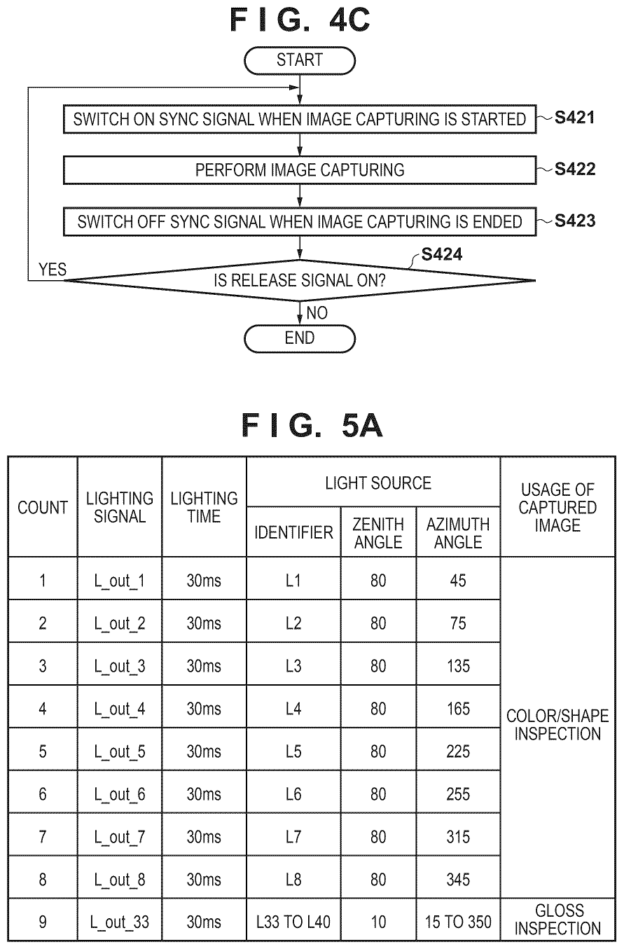

The image processing apparatus 104 is a personal computer, for example, and performs image processing on images obtained from the image capture apparatus 103. The image processing apparatus 104 includes a RAM 126, a ROM 127, a CPU 128, a GPU 129, and a USB interface (USB I/F) 130. These functional units are communicably connected to each other via an internal bus. Data for executing processing shown in the flowcharts depicted in FIGS. 4A to 4C to be described later is stored in the ROM 127 as program code. This program code is deployed to the RAM 126, and is executed by the CPU 128 or the GPU 129.

The mouse 106 and the keyboard 107 are communicably connected to the image processing apparatus 104 via the USB I/F 130, and accepts input from the user. Note that the image processing apparatus 104 according to the present embodiment is described as being connected to the mouse 106 and the keyboard 107, which serve as an input unit that accepts input from the user, but may include a different input unit such as a touch panel or a mechanical switch. The display 105 is connected to the GPU 129, and presents information to the user. The information processing apparatus 102, the image capture apparatus 103, and the conveyance control apparatus 111 are communicably connected to the image processing apparatus 104 via the USB I/F 130.

### Hardware Configurations of Conveyance Apparatus and Apparatuses Near Conveyance Apparatus

A conveyance apparatus 112 is a belt conveyer for conveying a target object 113. The conveyance apparatus 112 is controlled by the image processing apparatus 104 via the conveyance control apparatus 111. The conveyance control apparatus 111 is a one-board microcomputer that includes GPIO (General-purpose input/output) and a USB I/F. The conveyance control apparatus 111 obtains the status of the conveyance apparatus 112 via the GPIO. The image processing apparatus 104 obtains the status of the conveyance apparatus 112 from the conveyance control apparatus 111 via the USB I/F 130. In addition, the image processing apparatus 104 outputs a conveyance control instruction to the conveyance control apparatus 111 via the USB I/F 130. The conveyance control apparatus 111 controls the conveyance apparatus 112 via the GPIO based on the conveyance control instruction. Note that a PLC (Programmable Logic Controller) may be used as the conveyance control apparatus 111.

The start output I/F is the GPIO of the one-board microcomputer that constitutes the conveyance control apparatus 111. The conveyance control apparatus 111 outputs an image capture start signal to the information processing apparatus 102 via the start output I/F based on an image capture control instruction that is output from the image processing apparatus 104.

As described above, the image processing apparatus 104 according to the present embodiment performs a process of obtaining the status of the conveyance apparatus 112, a process of outputting a conveyance control instruction, and a process of outputting an image capture control instruction, via the conveyance control apparatus 111. Note that these three processes may be executed based on program code that is executed by the conveyance control apparatus 111.

### Hardware Configuration of Information Processing Apparatus

A description will be given below in which the information processing apparatus 102 according to the present embodiment is a one-board microcomputer that includes GPIO. However, the information processing apparatus 102 may be any apparatus having a configuration different from that described below as long as the apparatus can execute similar processing. The information processing apparatus 102 may also be a server that communicates with the image capture apparatus 103 and the illumination apparatus 108, a personal computer having a device control board including GPIO mounted therein, or an apparatus built in one of the image capture apparatus 103 and the illumination apparatus 108, for example.

The information processing apparatus 102 controls the image capture apparatus 103 and the illumination apparatus 108. Accordingly, the information processing apparatus 102 causes images of the target object 113-2 to be captured while turning on a plurality of light sources 109 that forms a multi-light illumination device, simultaneously or individually for a predetermined time in a predetermined order, and obtains a plurality of captured images in which the illumination direction differs. The information processing apparatus 102 includes a control unit 114, a start signal input interface (start input I/F) 115, a release signal output interface (release output I/F) 116, a sync signal input interface (sync input I/F) 117, a USB I/F 118, and a lighting signal output interface (lighting output I/F) 119. These functional units are communicably connected to each other via an internal bus.

The control unit 114 is a microcomputer that includes a RAM, a ROM, and a CPU. Data for executing processing shown in the flowcharts depicted in FIGS. 4A to 4C to be described later is stored in the ROM of the control unit 114 as program code. This program code is deployed to the RAM of the control unit 114, and is executed by the CPU of the control unit 114.

The USB I/F 118 is connected to the image processing apparatus 104 via the USB I/F 130. The image processing apparatus 104 stores program code that is executed by the control unit 114, in the ROM of the control unit 114 via the USB I/F 130 and the USB I/F 118.

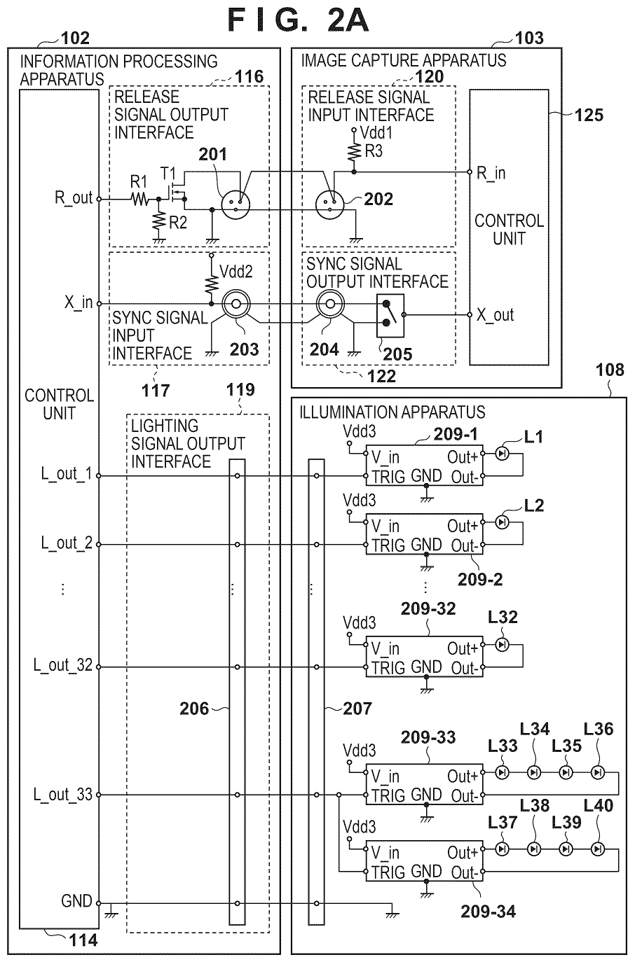

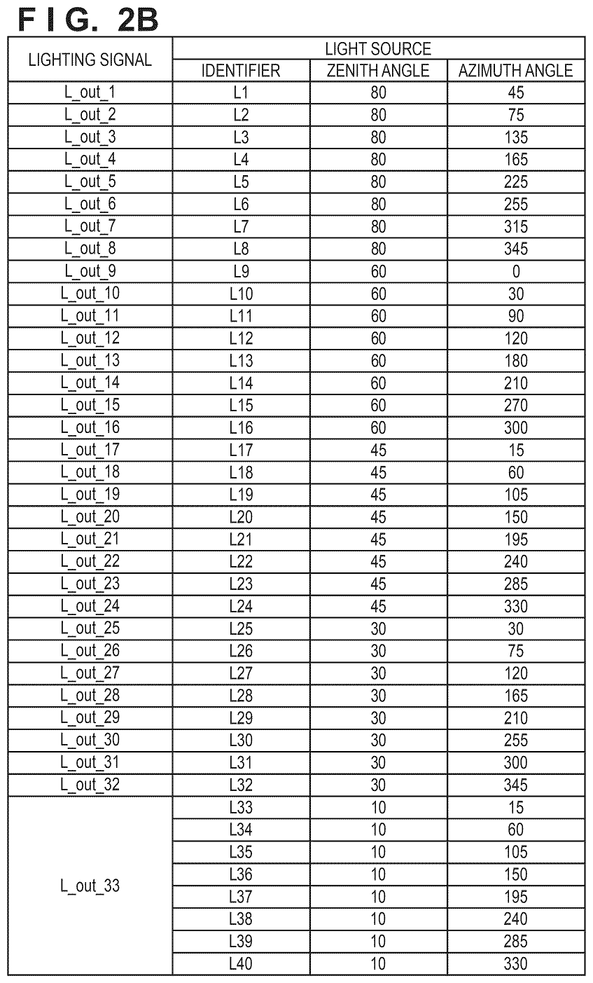

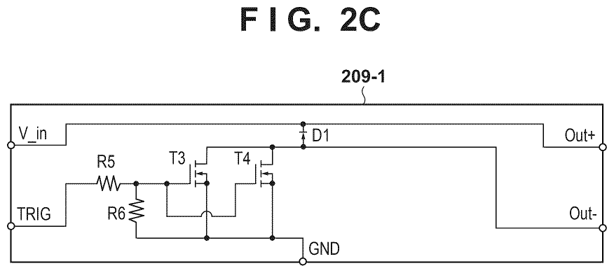

The start input I/F 115 is the GPIO of the one-board microcomputer that constitutes the information processing apparatus 102. In addition, the release output I/F 116, the sync input I/F 117, and the lighting output I/F 119 are connected to the GPIO of the one-board microcomputer that constitutes the information processing apparatus 102. A detailed description thereof will be given later with reference to FIGS. 2A to 2C.

The start input I/F 115 obtains an image capture start signal that is output from the start output I/F 101. The control unit 114 starts execution of program code stored in the ROM of the control unit 114 at a timing when the image capture start signal is input. Note that the image processing apparatus 104 may transmit an instruction instructing the control unit 114 to perform execution, stop, or the like of program code, to the control unit 114 via the USB I/F 130 and the USB I/F 118.

The release output I/F 116 outputs a release signal (image capture instruction signal) instructing that an image of a target object (subject) is captured, to a release input I/F 120 of the image capture apparatus 103. The release signal according to the present embodiment is an electrical signal that has two statuses, namely ON and OFF. The release signal is not limited to an electrical signal, and may be any signal that can instruct image capturing in a similar manner, and may be a wireless signal or an optical signal. The image capture apparatus 103 starts continuous image capturing at the timing when the release signal that is input is switched on. Next, the image capture apparatus 103 continues continuous image capturing while the release signal is on, and stops continuous image capturing at the timing when the release signal is switched off. The image capture apparatus 103 may be configured to receive both a signal instructing that continuous image capturing is activated and a signal instructing that continuous image capturing is deactivated, or may be configured to deactivate continuous image capturing after a predetermined period has passed from when a signal instructing that continuous image capturing is activated was received.

The sync input I/F 117 obtains an image capture timing signal (hereinafter, this will be referred to as a “sync signal”) that is output from the image capture apparatus 103 at timings for capturing respective still images during continuous image capturing, from a sync signal output interface (sync output I/F) 122 of the image capture apparatus 103. Note that the sync signal is an electrical signal that has two statuses, namely ON and OFF. The sync signal is not limited to an electrical signal, and may be any signal that indicates a timing for performing image capturing in a similar manner, and may be a wireless signal or an optical signal.

The lighting output I/F 119 outputs a lighting signal for controlling lighting of each of the light sources 109 of the illumination apparatus 108, to the illumination apparatus 108. Each time the sync signal that is input is switched on, the control unit 114 outputs a lighting signal to the illumination apparatus 108 via the lighting output I/F 119, and turns on a plurality of light sources 109 simultaneously or individually for a predetermined time in a predetermined order. In the present embodiment, the sync signal is switched on at timings for capturing respective still images during continuous image capturing, and thus the light sources 109 are turned on at timings for capturing respective still images during continuous image capturing.

As described above, the information processing apparatus 102 continuously captures images of the target object 113-2 while turning on a plurality of light sources that form the multi-light illumination device, simultaneously or individually for a predetermined time in a predetermined order, by controlling the image capture apparatus 103 and the illumination apparatus 108. Accordingly, the information processing apparatus 102 can obtain a plurality of captured images in which the illumination direction differs.

Note that, in the present embodiment, a description is given in which, when a state where the release signal is on is continued, continuous image capturing is performed, and a plurality of captured images are obtained. However, for example, a configuration may also be adopted in which image capturing is individually performed a plurality of number of times by repeatedly switching on and OFF the release signal a plurality of number of times, and a plurality of captured images are thereby obtained. However, for example, in a case where a consumer camera is used and image capturing is individually performed a plurality of number of times by repeatedly switching on and OFF the release signal a plurality of number of times, it is conceivable that the number of captured images per second is limited to some degree (for example, about five images). On the other hand, compared with such a case where image capturing is individually performed a plurality of number of times, in a case where continuous image capturing is performed, it is possible to capture a larger number of images (for example, several tens of images) per second. For this reason, even when using a camera with which the number of images that are captured per second is not sufficient when image capturing is individually performed a plurality of number of times, it is possible to ensure the number of images that are captured per second by performing continuous image capturing.

### Hardware Configuration of Image Capture Apparatus

The image capture apparatus 103 is a digital camera that captures images of the target object 113-2. In the present embodiment, a consumer lens-interchangeable single-lens camera is used as the image capture apparatus 103, but the image capture apparatus 103 may be either a consumer camera or an industrial camera.

The image capture apparatus 103 includes the release input I/F 120, an image capture optical system 121, a sync signal output interface 122, an image processing engine 123, a USB I/F 124, and a control unit 125. These functional units are communicably connected to each other via an internal bus.

The control unit 125 is a microcomputer that includes a RAM, a ROM, and a CPU. Data for executing processing shown in the flowcharts depicted in FIGS. 4A to 4C to be described later is stored in the ROM of the control unit 125 as program code. This program code is deployed to the RAM of the control unit 125, and is executed by the CPU of the control unit 125.

The release input I/F 120 obtains the release signal that is output from the release output I/F 116 of the information processing apparatus 102. At the timing when the release signal is input to the release input I/F 120, the control unit 125 controls the image capture optical system 121 constituted by a lens or an image sensor and the like to capture an image of the target object 113-2. Specifically, the control unit 125 starts continuous image capturing at the timing when the release signal is switched on. Next, the control unit 125 continues continuous image capturing while the release signal is on, and stops continuous image capturing at the timing when the release signal is switched off. Note that a function for continuing continuous image capturing while the release signal is on is a function that consumer lens-interchangeable single-lens cameras have in general.

During continuous image capturing, the control unit 125 outputs the sync signal at timings when respective still images are captured. Specifically, the control unit 125 outputs the sync signal to the sync input I/F 117 of the information processing apparatus 102 via the sync output I/F 122. A function for outputting a sync signal at timings when respective still images are captured during continuous image capturing is a function that consumer lens-interchangeable single-lens cameras have in general. The sync signal according to the present embodiment is a signal that is used in general in order to turn on an external stroboscope light source in synchronization with image capturing.

The image processing engine 123 generates digital image data based on an optical image on the image sensor, and stores the digital image data in the RAM or the ROM of the control unit 125 as a captured image. The USB I/F 124 is connected to the image processing apparatus 104 via the USB I/F 130.

The image processing apparatus 104 obtains a captured image stored in the RAM or the ROM of the control unit 125 of the image capture apparatus 103, via the USB I/F 124 and the USB I/F 130. The image processing apparatus 104 stores the obtained captured image in the RAM 126 or the ROM 127 of the image processing apparatus 104. In addition, the image processing apparatus 104 sets image capture modes of the image capture apparatus 103 (ISO sensitivity, a shutter speed, aperture, a continuous image capture mode, an image capture area, an image format, and the like), via the USB I/F 130 and the USB I/F 124.

Note that a portion or the entirety of processing that will be described below as being executed by the image processing apparatus 104 may be executed by the information processing apparatus 102. In addition, a portion of processing that is executed by the image capture apparatus 103 may be executed by the information processing apparatus 102. In addition, as long as similar processing can be executed in the image processing system 1, a portion of processing that is executed by the information processing apparatus 102 may be executed by the image capture apparatus 103 or the image processing apparatus 104.

### Hardware Configuration of Illumination Apparatus

The illumination apparatus 108 is a dome-shaped multi-light illumination device that includes a plurality of light sources. In the image processing system 1 according to the present embodiment, as shown in FIG. 1B, the image capture apparatus 103 is disposed at the apex of the dome. The illumination apparatus 108 emits light from a plurality of directions to the target object 113-2.

FIG. 1D is a side view showing an example of arrangement of the light sources 109 on the illumination apparatus 108. FIG. 1E is a top view showing an example of arrangement of the light sources 109 on the illumination apparatus 108. In FIGS. 1D and 1E, the light sources 109 are respectively represented by black squares. As shown in FIG. 1E, the illumination apparatus 108 according to the present embodiment includes 40 light sources as the light sources 109. As shown in FIG. 1D, these 40 light sources are disposed at positions of five zenith angles, namely 10°, 30°, 45°, 60°, and 80°. In addition, as shown in FIG. 1E, these 40 light sources are disposed at a 15° interval at the positions of 24 azimuth angles from 0° to 345°. By controlling the image capture apparatus 103 and the illumination apparatus 108, the information processing apparatus 102 continuously captures images of the target object 113-2 while turning on a plurality of light sources 109 that form the multi-light illumination device, simultaneously or individually for a predetermined time in a predetermined order. Accordingly, the information processing apparatus 102 can obtain a plurality of captured images in which the illumination direction differs.

Note that, as will be described later, in the present embodiment, eight light sources at the zenith angle of 10° are simultaneously turned on and light sources at the zenith angles of 30° to 80° are individually turned on. Assuming that all of the light sources have the same power consumption, the total power consumption in a case where light sources are simultaneously turned on is larger than that in a case where the light sources are individually turned on. The larger the total power consumption is, the higher the cost of the power supply apparatus becomes. In addition, a light emission amount of a light source is roughly proportional to the power consumption of the light source. For this reason, when light sources are simultaneously turned on, an image becomes too bright compared with a case where light sources are individually turned on, and pixels may saturate. In view of this, as light sources that are simultaneously turned on, light-emission devices whose power consumption is smaller than light sources that are individually turned on are used. That is to say, light-emission devices that have smaller power consumption than the light sources at the other zenith angles are used as the light sources at the zenith angle of 10°, which are assumed to be simultaneously turned on. For this reason, in FIGS. 1D and 1E, when the light sources are represented by black squares, the light sources at the zenith angle of 10° are represented by black squares that are smaller than other light sources.

### Circuit Configuration

FIG. 2A is a diagram showing exemplary hardware circuits in the image processing system 1 according to the present embodiment. FIG. 2B is an explanatory view showing the correspondence relationship between lighting signal and light source 109. FIG. 2C is a circuit diagram of a switching module (209-1 to 209-34).

### Circuit Configuration of Information Processing Apparatus

The information processing apparatus 102 according to the present embodiment can transmit the release signal to the image capture apparatus 103 by controlling the current-carrying state of a terminal that transmits the release signal. In addition, the information processing apparatus 102 can receive the sync signal from the image capture apparatus 103 by controlling the current-carrying state of a terminal that receives the sync signal. The current-carrying states of such terminals will be described below.

The control unit 114 of the information processing apparatus 102 includes R_out, X_in, and L_out_1 to L_out_33 as GPIOs. In addition, the control unit 114 also includes a ground terminal GND that has a reference potential. The potentials of the GPIOs are controlled by program code that is executed by the control unit 114. The control unit 114 switches the potentials of the GPIOs from a low potential to a high potential, or from a high potential to a low potential. Accordingly, the control unit 114 outputs the release signal from R_out. In addition, the control unit 114 outputs lighting signals using L_out_1 to L_out 33. In addition, the control unit 114 can obtain the potentials of the GPIOs. That is to say, the control unit 114 determines whether the potential of each GPIO is a high potential or a low potential. Accordingly, the control unit 114 obtains the sync signal from X_in. Note that, in the following description, a high potential is set to 5 V and a low potential to 0 V as potentials relative to the ground.

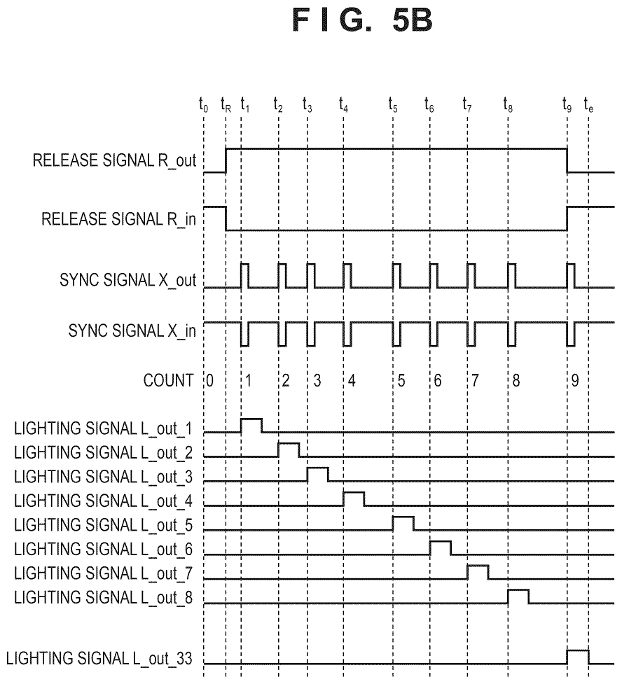

R_out out of the GPIOs outputs the release signal to the image capture apparatus 103 via a remote control terminal 201 of the release output I/F 116. X_in obtains the sync signal from the image capture apparatus 103 via a sync terminal 203 of the sync input I/F 117. L_out_1 to L_out_33 outputs lighting signals to the illumination apparatus 108 via a terminal 206 of the lighting output I/F 119. As shown in FIG. 5B, the GPIOs (L_out_1 to L_out_33) that output lighting signals turn on the respective light sources connected thereto for a predetermined time, for example, by outputting signals at a high potential for a predetermined period at the timing when the sync signal is obtained. On the other hand, the GPIOs that output lighting signals turn off the respective light sources connected thereto by outputting signals at a low potential. Note that the GPIOs that output lighting signals may output PWM signals as the lighting signals. In a case where a PWM signal is used as a lighting signal, it is possible to individually adjust the light emission amounts of the respective light sources connected to the GPIOs by adjusting the duty ratios of the PWM signals.

The release output I/F 116 of the information processing apparatus 102 controls the current-carrying state between the two terminals of the remote control terminal 201 based on the potential of R_out. Accordingly, the release signal is output to the image capture apparatus 103. The release output I/F 116 includes an N-channel MOSFET (T1), a gate resistor R1, and a gate-source resistor R2, and the remote control terminal 201. The gate of the MOSFET (T1) is connected to R_out of the control unit 114 via the gate resistor R1. In addition, the gate of the MOSFET (T1) is connected to the ground via the gate-source resistor R2. The source of the MOSFET (T1) is connected to the ground. The drain and source of the MOSFET (T1) are respectively connected to the two terminals of the remote control terminal 201. The drain-source path of the MOSFET (T1) is energized when R_out of the control unit 114 is at a high potential, and is disconnected when R_out is at a low potential. The control unit 114 controls the current-carrying state of the drain-source path of the MOSFET (T1) by switching the potential of R_out. That is to say, the control unit 114 controls the current-carrying state between the two terminals of the remote control terminal 201 by switching the potential of R_out. Accordingly, the control unit 114 outputs the release signal to the image capture apparatus 103. Specifically, when the release signal is on, the control unit 114 sets R_out to a high potential to cause a current to be carried between the two terminals of the remote control terminal 201. On the other hand, when the release signal is off, the control unit 114 sets R_out to a low potential to disconnects conduction between the two terminals of the remote control terminal 201. Note that, in order to control the current-carrying state between the two terminals of the remote control terminal 201, a known switching element may be used in place of the MOSFET.

The sync input I/F 117 of the information processing apparatus 102 converts the current-carrying state between the two terminals of the sync terminal 203 into the potential of X_in. The two terminals of the sync terminal 203 are connected to a remote control terminal 202 of the image capture apparatus 103, and is further connected to a semiconductor switching element 205 of the image capture apparatus 103. That is to say, the sync input I/F 117 converts the current-carrying state of the semiconductor switching element 205 into the potential of X_in. The semiconductor switching element 205 is energized at the timing when the image capture apparatus 103 captures each still image, and is disconnected at other timings. For this reason, the potential of X_in changes at the timing when each still image is captured. By obtaining the potential of X_in, the control unit 114 obtains the sync signal that is output at the timing when the image capture apparatus 103 captures each still image during continuous image capturing. The sync input I/F 117 includes a pull-up resistor R4 and the sync terminal 203. X_in of the control unit 114 is connected to one terminal of the sync terminal 203. The other terminal of the sync terminal 203 is connected to the ground. X_in of the control unit 114 is connected to a power supply Vdd2 via the pull-up resistor R4. The power supply Vdd2 is at a high potential, and the potential thereof relative to the ground is 5 V. For this reason, X_in is at a high potential in a state where the two terminals of the sync terminal 203 are disconnected, and is at a low potential in a state where a current is carried between the two terminals of the sync terminal 203. The two terminals of the sync terminal 203 enters a current-carrying state at the timing when the image capture apparatus 103 captures a still image, and enters a disconnected state at the other timings. For this reason, by obtaining the potential of X_in, the control unit 114 can obtain the timing for the image capture apparatus 103 to capture a still image. That is to say, by obtaining the potential of X_in, the control unit 114 can obtain the sync signal that is output by the image capture apparatus 103 at the timings when respective still images are captured during continuous image capturing. Specifically, when the sync signal is on, the two terminals of the sync terminal 203 are energized, and X_in is at a low potential. On the other hand, when the sync signal is off, the two terminals of the sync terminal 203 are disconnected, and X_in is at a high potential.

### Circuit Configuration of Image Capture Apparatus

The control unit 125 of the image capture apparatus 103 includes R_in and X_out as GPIOs. R_in obtains the release signal from the information processing apparatus 102 via the remote control terminal 202 of the release input I/F 120. X_out outputs the sync signal to the information processing apparatus 102 via the sync terminal 204 of the sync output I/F 122. Note that the remote control terminal 202 is connected to the remote control terminal 201. In addition, the sync terminal 204 is connected to the sync terminal 203.

The release input I/F 120 of the image capture apparatus 103 converts the current-carrying state of the drain-source path of the MOSFET (T1) of the release output I/F 116, into the potential of R_in. As described above, the current-carrying state of the drain-source path of the MOSFET (T1) is controlled by the potential of R_out. For this reason, the potential of R_in is controlled by the potential of R_out. Accordingly, the release signal that is output by the control unit 114 of the information processing apparatus 102 is transmitted to the control unit 125 of the image capture apparatus 103. As shown in FIG. 5B, the potential of R_in is an inverted potential of the potential of R_out. The release input I/F 120 includes a pull-up resistor R3 and the remote control terminal 202. R_in of the control unit 125 is connected to one terminal of the remote control terminal 202. The other terminal of the remote control terminal 202 is connected to the ground. R_in of the control unit 125 is connected to a power supply Vdd1 via the pull-up resistor R3. The power supply Vdd1 is at a high potential, and the potential thereof relative to the ground is 5 V. For this reason, R_in is at a high potential in a state where the two terminals of the remote control terminal 202 are disconnected, and is at a low potential in a state where a current is carried between the two terminals of the remote control terminal 202. As described above, the current-carrying state between the two terminals of the remote control terminal 201 is switched by the release signal that is output by the control unit 114. In addition, the remote control terminal 202 is connected to the remote control terminal 201. For this reason, the control unit 125 can obtain the release signal that is output by the information processing apparatus 102, by obtaining the potential of R_in. Specifically, when the release signal is on, a current is carried between the two terminals of the remote control terminal 201, and thus R_in is at a low potential. On the other hand, when the release signal is off, the two terminals of the remote control terminal 201 are disconnected, and thus R_in is at a high potential. The control unit 125 starts continuous image capturing at the timing when R_in changes to a low potential. Next, the control unit 125 continues continuous image capturing while R_in is at a low potential, and stops continuous image capturing at the timing when R_in changes to a high potential.

The sync output I/F 122 of the image capture apparatus 103 controls the current-carrying state between the two terminals of the semiconductor switching element 205 based on the potential of X_out. The current-carrying state of the semiconductor switching element 205 is converted is into the potential of X_in by the sync input I/F 117 of the information processing apparatus 102. For this reason, the potential of X_in is controlled by the potential of X_out. Accordingly, the sync signal that is output by the control unit 125 of the image capture apparatus 103 is transmitted to the control unit 114 of the information processing apparatus 102. As shown in FIG. 5B, the potential of X_in is an inverted potential of the potential of X_out. The sync output I/F 122 includes the semiconductor switching element 205 and the sync terminal 204. The semiconductor switching element 205 is connected to X_out of the control unit 125. The control unit 125 controls the current-carrying state of the semiconductor switching element 205 by switching the potential of X_out. The semiconductor switching element 205 is connected to the sync terminal 204, and one of the two terminals thereof is connected to the ground. For this reason, a current is carried between the two terminals of the sync terminal 204 when X_out of the control unit 125 is at a high potential, and the two terminals are disconnected when X_out is at a low potential. That is to say, the control unit 125 controls the current-carrying state between the two terminals of the sync terminal 204 by switching the potential of X_out. Accordingly, the control unit 125 outputs the sync signal to the information processing apparatus 102. Specifically, when the sync signal is switched on, the control unit 125 changes X_out to a high potential to cause a current to be carried between the two terminals of the sync terminal 204. On the other hand, when the sync signal is switched off, the control unit 125 changes X_out to a low potential to disconnect the two terminals of the sync terminal 204. As described above, the sync terminal 203 is connected to the sync terminal 204. In addition, as described above, the potential of X_in of the control unit 114 of the information processing apparatus 102 is switched based on the current-carrying state of the sync terminal 203. For this reason, the control unit 114 of the information processing apparatus 102 can obtain the sync signal that is output by the image capture apparatus 103 by obtaining the potential of X_in.

Note that the remote control terminal 201 and the remote control terminal 202 according to the present embodiment are remote control terminals that lens-interchangeable single-lens cameras have in general. In general, remote control terminals of lens-interchangeable single-lens cameras are used for connection of remote controllers for remote release. Similarly, the sync terminal 203 and the sync terminal 204 according to the present embodiment are sync terminals that lens-interchangeable single-lens cameras have in general. In general, sync terminals of lens-interchangeable single-lens cameras are used for connecting external stroboscope light sources to cameras. Note that lens-interchangeable single-lens cameras of some models do not include a sync terminal. In a case where such a lens-interchangeable single-lens camera is used, a sync signal may be output to the information processing apparatus 102 by using a hot shoe adapter that includes a sync terminal and is mounted on a camera body.

### Circuit Configuration of Illumination Apparatus

The illumination apparatus 108 includes a terminal 207, switching modules (209-1 to 209-34), and 40 light sources (L1 to L40). Here, all of the light sources are LEDs. The terminal 207 inputs lighting signals that are output from the GPIOs (L_out_1 to L_out_33) of the control unit 114 via the terminal 206. In addition, the terminal 207 is connected to the ground terminal GND of the control unit 114. Switching modules (209-1 to 209-34) amplify lighting signals that are input from the terminal 207, and turn on the light sources (L1 to L40).

FIG. 2B is an explanatory view showing the correspondence relationship between lighting signals and the light sources 109. The light sources L1 to L32 are respectively connected to the GPIOs (L_out_1 to L_out_32). For this reason, the control unit 114 can individually perform on/off control of L1 to L32. On the other hand, the light sources L33 to L40 are connected to a single GPIO (L_out_33). For this reason, the control unit 114 simultaneously turns on L33 to L40 and simultaneously turns off L33 to L40. Note that, L33 to L36 from among L33 to L40 are connected in series, and are connected to the switching module 209-33. Similarly, L37 to L40 are connected in series, and are connected to the switching module 209-34. Note that light sources are not limited to LEDs as long as lighting control can be performed similarly, and xenon lamps may be used as the light sources, for example.

FIG. 2C is a circuit diagram of a switching module (209-1 to 209-34). In the present embodiment, a description will be given in which all of the switching modules (209-1 to 209-34) have the same configuration, and thus the configuration of the switching module 209-1 will be described below as an example.

The switching module 209-1 amplifies a lighting signal that is output by the control unit 114 to turn on the light source L1. The switching module 209-1 includes two N-channel MOSFETs (T3 and T4), a gate resistor R5, a gate-source resistor R6, and a diode D1. The MOSFETs (T3 and T4) are connected in parallel to supply a large current to the light source L1. Note that known switching elements may be appropriately adopted in place of the MOSFETs (T3 and T4).

The gates of the MOSFETs (T3 and T4) are connected to a TRIG terminal to which a lighting signal is input, via the gate resistor R5. In addition, the gates of the MOSFETs (T3 and T4) are connected to the ground via the gate-source resistor R6. In addition, the sources of the MOSFETs (T3 and T4) are connected to the ground. The drain-source paths of the MOSFETs (T3 and T4) are energized when the TRIG terminal is at a high potential, and are disconnected when the TRIG terminal is at a low potential. The control unit 114 according to the present embodiment can control the current-carrying states of the drain-source paths of the MOSFETs (T3 and T4) by switching the potential of the lighting signal. Accordingly, on/off control of the light source is performed.

The light source is turned on when the lighting signal is at a high potential, and is turned off when the lighting signal is at a low potential. The drains of the MOSFETs (T3 and T4) are connected to the cathode of the light source L1 via an Out-terminal. A V_in terminal is a terminal connected to a power supply Vdd3. This V_in terminal is connected to the anode of the light source L1 via an Out+terminal. For this reason, when the drain-source paths of the MOSFETs (T3 and T4) are energized, the light source L1 is turned on, and when the drain-source paths of the MOSFETs (T3 and T4) are disconnected, the light source L1 is turned off. Note that, between the Out+terminal and the Out-terminal, a diode D1 for preventing a surge current is connected. Specifically, the cathode of the diode D1 is connected to the Out+terminal. In addition, the anode of the diode D1 is connected to the Out-terminal. Normally, the potential of the Out+terminal is higher than the Out-terminal due to the load of the light source L1, and thus the diode D1 does not conduct current.

Note that the light emission amount of the light source may change depending on temperature changes in circuit elements. For this reason, in the present embodiment, a constant current power supply is used as the power supply Vdd3. The power supply Vdd3 has a current value of 0.6 A and a potential of up to 36 V relative to the ground. In a case where an LED is used as the light source, the light emission amount thereof is highly dependent on a current value. In this case, by stabilizing the current value using the constant current power supply, the light emission amount of the light source can be maintained at a consistent value irrelevantly of temperature changes in the circuit elements. In addition, by adjusting a current value using the constant current power supply, the light emission amount of the light source can be adjusted. Furthermore, by connecting different constant current power supplies to respective light sources, the light emission intensity can be adjusted for each light source.

### Functional Configuration and Processing Flow

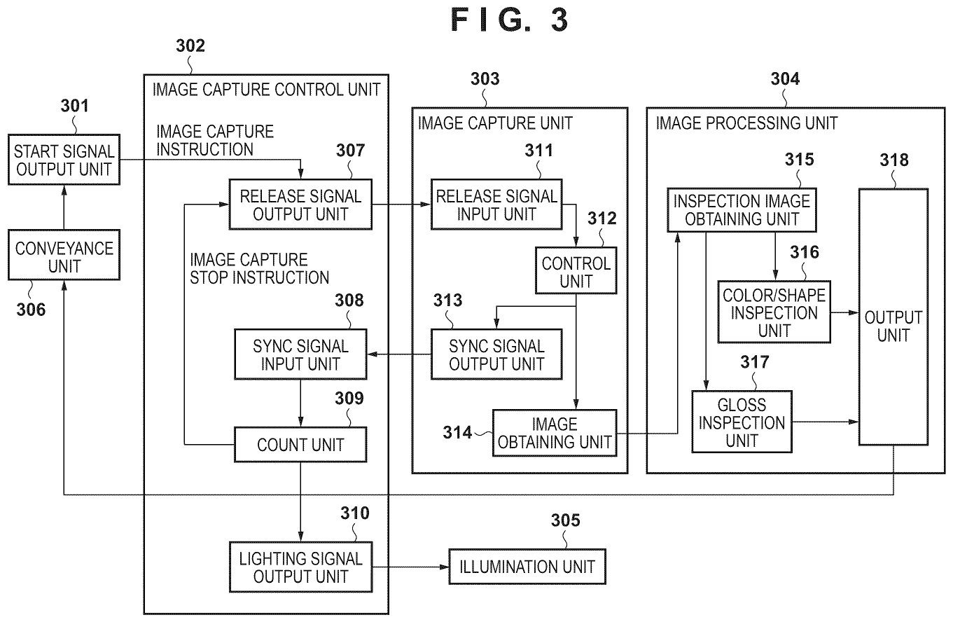

FIG. 3 is a block diagram showing an exemplary functional configuration of the image processing system 1 according to the present embodiment. The image processing system 1 according to the present embodiment is constituted by a start signal output unit 301, an image capture control unit 302, an image capture unit 303, an image processing unit 304, an illumination unit 305, and a conveyance unit 306. The image capture control unit 302 includes a release signal output unit 307, a sync signal input unit 308, a count unit 309, and a lighting signal output unit 310. The image capture unit 303 includes a release signal input unit 311, a control unit 312, a sync signal output unit 313, and an image obtaining unit 314. The image processing unit 304 includes an inspection image obtaining unit 315, a color/shape inspection unit 316, a gloss inspection unit 317, and an output unit 318.

The functional units shown in FIG. 3 are realized by the hardware shown in FIGS. 1A to 1E and the circuits shown in FIGS. 2A to 2C. Specifically, functions of the start signal output unit 301 are realized by the start output I/F 101, the conveyance control apparatus 111, and the image processing apparatus 104. Functions of the image capture control unit 302 are realized by the information processing apparatus 102. Functions of the image capture unit 303 are realized by the image capture apparatus 103. Functions of the image processing unit 304 are realized by the image processing apparatus 104. Functions of the illumination unit 305 are realized by the illumination apparatus 108. Functions of the conveyance unit 306 are realized by the conveyance control apparatus 111, the conveyance apparatus 112, and the image processing apparatus 104.

FIGS. 4A to 4C are flowcharts showing an example of information processing that is executed in the image processing system 1 according to the present embodiment. In addition, FIGS. 5A and 5B are diagrams for describing the information processing.

### Overall Processing

First, an overview of overall processing will be described. FIG. 4A is a flowchart showing an example of conveyance and image capture processing of a target object. The processing illustrated in FIG. 4A is processing for capturing images of the target object while causing the conveyance apparatus 112 to intermittently operate. That is to say, here, the conveyance apparatus 112 repeats operation and stop alternately. In addition, the target object is conveyed to an image capture position as a result of the conveyance apparatus 112 operating, and an image of the target object is captured in a state where the conveyance apparatus 112 is stopped. When image capturing is complete, the target object is conveyed from the image capture position to another location as a result of the conveyance apparatus 112 operating.

The processing shown in FIG. 4A is started when an instruction to start the overall operations is given (for example, through a user operation performed on the information processing apparatus 102). In step S401, the conveyance unit 306 causes the conveyance apparatus 112 to operate to start conveyance of the target object. In step S402, the conveyance unit 306 determines whether or not the target object has been conveyed to the image capture position (position of the target object 113-2). The conveyance unit 306 may determine whether or not the target object has been conveyed to the image capture position, for example, using an optical sensor installed in the vicinity of the image capture position. If it is determined that the target object has been conveyed to the image capture position, the procedure advances to step S403, otherwise the procedure repeats step S402. In step S403, the conveyance unit 306 stops the conveyance apparatus 112 to stop conveyance of the target object.

In the processing shown in FIG. 4A, the conveyance apparatus 112 is stopped during a period of steps S403 to S407. During this time, the target object is transported by a robotic arm from outside, and is placed at the position of the target object 113-1 in the conveyance apparatus 112. The robot arm is controlled by the image processing apparatus 104 via the conveyance control apparatus 111.

In step S404, the image capture control unit 302 controls the image capture unit 303 and the illumination unit 305 to capture an image of the target object at the image capture position. Specifically, the image capture control unit 302 captures an image of the surface of the target object while turning on a plurality of light sources (among the light sources L1 to L40 shown in FIG. 2A) that form the multi-light illumination device, simultaneously or individually for a predetermined time in a predetermined order. Accordingly, the image capture control unit 302 obtains a plurality of captured images in which the illumination direction differs. Note that, here, processing for sending an image capture start signal is performed by an apparatus different from the apparatus that controls lighting of light sources and image capturing (the information processing apparatus 102). The processing for sending an image capture start signal may be performed using the image processing apparatus 104, the conveyance control apparatus 111, or the like. Accordingly, a delay in processing of program code that is executed by the information processing apparatus 102 is reduced, and thus it is possible to more accurately align lighting timings of light sources with image capture timings. Note that, here, image capturing of the target object is executed by the start signal output unit 301 sending an image capture start signal to the release signal output unit 307 of the image capture control unit 302.

In steps S405 and S406, the image processing unit 304 performs appearance inspection processing of the target object based on images captured in step S404. Here, in step S405, the color/shape inspection unit 316 performs color/shape inspection of the target object based on images captured in step S404. Next, in step S406, the gloss inspection unit 317 performs gloss inspection processing of the target object based on images captured in step S404. Here, when image capture processing in step S404 is complete, a plurality of captured images stored in the image obtaining unit 314 are sent to the inspection image obtaining unit 315. The image processing unit 304 of the image processing apparatus 104 performs image processing based on the obtained captured images. In the present embodiment, an industrial product such as a household appliance or cosmetics is envisioned as the target object 113-2. Here, the image processing unit 304 performs appearance inspection processing of the surface of the target object 113-2 based on the obtained captured images. Next, the output unit 318 presents the inspection result to the user via the display 105. In addition, the output unit 318 notifies the inspection result to the conveyance unit 306.

Note that, here, a description is given in which appearance inspection is performed based on captured images in steps S405 and S406, but processing that is executed using captured images here is not limited thereto. In step S405, the color/shape inspection unit 316 may estimate the normal distribution of the surface of the target object 113-2 based on a plurality of obtained captured images, using the photometric stereo method, for example.

Such appearance inspection processing will be described below with reference to FIGS. 5A and 5B. FIG. 5A shows an example of parameter setting values when images of a single target object is captured and appearance inspection processing is performed. FIG. 5B shows an example of waveforms of signals when image capturing is performed based on the parameter setting values shown in FIG. 5A. Assume that the parameter setting values shown in FIG. 5A are set by the user via the mouse 106 and the keyboard 107. In the parameter setting values in FIG. 5A, for the counts from 1 to 9, the GPIOs (L_out_1 to L_out_8 and L_out_33) that output lighting signals, lighting periods, the light sources that are turned on, and usages of captured images are associated with each other. In the case in FIG. 5A, nine captured images are obtained in correspondence the counts from 1 to 9. The lighting periods in FIG. 5A correspond to periods during which the lighting signals are on. In the example in FIG. 5A, when the count is 1, a lighting signal L_out_1 is switched on for 30 milliseconds, and the light source L1 is thereby turned on for 30 milliseconds. In addition, when the count is 2, a lighting signal L_out_2 is switched on for 30 milliseconds, and the light source L2 is thereby turned on for 30 milliseconds. Similarly, when the count is 9, a lighting signal L_out_33 is switched on for 30 milliseconds, and the light sources L33 to L40 are thereby turned on simultaneously for 30 milliseconds. Here, as shown in FIG. 5A, while the count is in the range of 1 to 8, eight light sources L1 to L8 are individually turned on sequentially. On the other hand, when the count is 9, eight light sources L33 to L40 are simultaneously turned on.

The information processing apparatus 102 according to the present embodiment can perform inspection of the color or shape of a target object or inspection of gloss as appearance inspection processing of the target object, based on a plurality of captured images. When appearance inspection processing of the surface of the target object 113-2 is performed, first, the inspection image obtaining unit 315 allots a plurality of captured images to the color/shape inspection unit 316 and the gloss inspection unit 317. The eight light sources L1 to L8 that are turned on when the count is 1 to 8 have a zenith angle of 80°, thus being able to emit light from a relatively low angle to the target object 113-2, as shown in FIG. 1D. Captured images obtained at this time contain almost no regular reflective components, and thus it is conceivable that the images are suitable for colors/shape inspection of the surface of the target object 113-2. In addition, emitting light from a low angle enhances the contrast of shadows formed by the shape of the surface of the target object 113-2, and thus it is conceivable that captured images that are obtained at this time are suitable for shape inspection. For this reason, color/shape inspection is set as a usage of eight captured images that are obtained when the count is 1 to 8, in the example in FIG. 5A. The inspection image obtaining unit 315 outputs the eight captured images obtained when the count was 1 to 8, to the color/shape inspection unit 316 based on this setting.

On the other hand, eight light sources L33 to L40 that are simultaneously turned on when the count is 9 have a zenith angle of 10°, thus being able to emit light to the target object 113-2 from a relatively high angle as shown in FIG. 1D. A captured image that is obtained at this time contains a large amount of regular reflective components, and thus it is conceivable that the image is suitable for gloss inspection of the surface of the target object 113-2. For this reason, gloss inspection is set as a usage of one captured image that is obtained when the count is 9, in the example in FIG. 5A. The inspection image obtaining unit 315 outputs one captured image obtained when the count was 9 to the gloss inspection unit 317 based on this setting.

Then, in step S405, the color/shape inspection unit 316 performs color/shape inspection of the surface of the target object based on the captured images allotted by the inspection image obtaining unit 315, and outputs the result to the output unit 318. Similarly, in step S406, the gloss inspection unit 317 performs gloss inspection of the surface of the target object based on the captured image allotted by the inspection image obtaining unit 315, and outputs the result to the output unit 318.

Specifically, the color/shape inspection unit 316 and the gloss inspection unit 317 extract a defective area of the surface of the target object 113-2 by applying predetermined spatial filter processing to each captured image. A DoG (Difference of two Gaussian) filter that supports a spatial scale that is extracted is used as a spatial filter, for example. Threshold processing is then applied to the image to which the spatial filter processing has been applied, and, if there is no pixel that exceeds a predetermined threshold, it is determined that the image has passed the inspection, and, if there is any pixel that exceeds the predetermined threshold, it is determined that the image has failed the inspection. In this manner, the color/shape inspection unit 316 and the gloss inspection unit 317 determine whether each captured image has passed or failed inspection, and, if all of the captured images have passed inspection (here, both color/shape inspection and gloss inspection), information indicating “inspection passed” is output as a final result. On the other hand, if there is even a single captured image that has failed inspection, information indicating “inspection failed” is output as a final result.

Note that inspection processing that is performed here is not limited thereto, and known any inspection processing that uses a captured image may be adopted. As an inspection processing method, for example, processing described in Patent Document 1 may be executed.

In step S407, the conveyance unit 306 determines whether or not image capturing of all of the target objects is complete. If image capturing of all of the target objects is complete, the processing shown in FIG. 5A ends, otherwise the procedure returns to step S401. Note that, here, at the timing when the conveyance apparatus 112 operates, the target object for which image capturing is complete is conveyed to the position of the target object 113-2, and is transported to the outside by a robotic arm.

Note that, in the present embodiment, the robot arm is controlled by the image processing apparatus 104 via the conveyance control apparatus 111. Specifically, if the result of inspection is “passed”, the image processing apparatus 104 transports the target object 113-2 to a tray for storing products that have passed inspection, by controlling the robot arm. On the other hand, if the result of inspection is “failed”, the image processing apparatus 104 transports the target object 113-2 to a tray for storing products that have failed inspection, by controlling the robot arm. In this manner, in the present embodiment, processing of post-processes that is performed based on the result of inspection is performed by an apparatus different from the apparatus that controls lighting of the light sources and image capturing (the information processing apparatus 102). Accordingly, a delay in processing of program code that is being executed by the information processing apparatus 102 is reduced, and thus it is possible to more accurately align lighting timings of light sources with image capture timings.

### Detailed Processing of Step S404

Next, step S404 will be described in detail with reference to FIG. 4B. In step S404, the image capture control unit 302 controls the image capture unit 303 and the illumination unit 305 to capture images of the target object at the image capture position. FIG. 4B shows the flow of processing that is performed by the image capture control unit 302. Note that the processing of steps S409 to S420 shown in FIG. 4B is executed by program code that is read out by the information processing apparatus 102.

First, after conveyance of the target object has been stopped in step S403, the start signal output unit 301 sends an image capture start signal to the release signal output unit 307 of the image capture control unit 302. When the image capture start signal is input, the image capture control unit 302 sets the count of the sync signal to 0 in step S409. FIG. 5B shows a situation where, at time t0, the count is set to 0.

Next, in step S410, the release signal output unit 307 sends a release signal to the release signal input unit 311. FIG. 5B shows a situation where, at time tR, the release signal is switched from off to on. At time tR, R_out of the control unit 114 of the information processing apparatus 102 is switched from a low potential to a high potential at the timing when the release signal is switched from off to on. On the other hand, at time tR, R_in of the control unit 125 of the image capture apparatus 103 is switched from a high potential to a low potential at the timing when the release signal is switched from off to on. Then, during the period from time tR to time t9, a state where the release signal is on continues. During this period, the image capture unit 303 performs continuous image capturing, and obtains nine captured images.

Note that, in the present embodiment, on/off control of the release signal is performed based on the number of times the sync signal output from the image capture unit 303 was obtained. Here, the image capture control unit 302 can count the number of times the sync signal output from the image capture unit 303 was obtained, and switch off the release signal at a timepoint when the count reaches a predetermined number of times. In the case in FIG. 5A, for example, the image capture control unit 302 switches OFF the release signal at the timepoint when the count of the sync signal reaches 9. By performing such processing, it is possible to stop continuous image capturing at the timepoint when the number of obtained still images reaches a predetermined number of images.

In addition, image capture processing that is performed by the image capture unit 303 in accordance with the sync signal will be described with reference to FIG. 4C. FIG. 4C is a flowchart showing an example of image capture processing that is performed by the image capture unit 303. Processing of each of steps S421 to S424 shown in FIG. 4C is executed by program code that is read out by the image capture apparatus 103.

First, at time tR shown in FIG. 5B, the release signal input unit 311 obtains the release signal from the release signal output unit 307. At the timing when the release signal is switched on, the control unit 312 controls the image obtaining unit 314 and the sync signal output unit 313 to start continuous image capturing, continues continuous image capturing while the release signal is on, and stops continuous image capturing at the timing when the release signal is switched off.

When the release signal is switched on at time tR, the image obtaining unit 314 starts image capturing at the timing of time t1. Note that the period from time tR to time t1 is a release time lag, and, when a consumer camera is used as the image capture apparatus 103, the period from time tR to time t1 changes each time.

In step S421, the sync signal output unit 313 switches on the sync signal at time t1 when image capturing is started, simultaneously with image capturing that is started at time t1. That is to say, in step S421, the sync signal output unit 313 outputs the sync signal to the sync signal input unit 308 of the image capture control unit 302, at time t1. Note that, here, the timing when image capturing is started is the timing when exposure is started.

In step S422, the image obtaining unit 314 performs exposure during a period corresponding to the shutter speed setting value, and captures an image of the target object. Next, in step S423, the sync signal output unit 313 switches OFF the sync signal at the timing when image capturing is ended. That is to say, in the processing in FIG. 4C, the sync signal is on during the exposure period, and is off during a period during which exposure is not performed. Note that, in the present embodiment, the shutter speed setting value is 1/60 seconds.

In step S424, the release signal input unit 311 determines whether or not the release signal is on. If the release signal is on, the procedure returns to step S401, and continuous image capturing is continued, otherwise (at the timing when the release signal is switched off), the processing in FIG. 4C ends, and continuous image capturing stops.

FIG. 5B shows a situation where the sync signal changes in continuous image capturing. In the example in FIG. 5B, the period during which the release signal is on is the period from time tR to time t9. During this period, continuous image capturing is performed and nine still images are captured. When each still image is captured, X_out of the control unit 125 of the image capture apparatus 103 is switched from a low potential to a high potential, at the timing when the sync signal is switched from off to on at a start of image capturing. On the other hand, X_in of the control unit 114 of the information processing apparatus 102 is switched from a high potential to a low potential at the timing when the sync signal is switched from off to on at a start of image capturing. The lighting signals are switched from off to on in synchronization with the timing when the sync signal is switched from off to on, and the ON state continues for a predetermined time. In the case in FIG. 5A, lighting periods are uniformly set to 30 milliseconds, and thus the light sources are turned on for 30 milliseconds, in alignment with image capture timings.

Note that, here, a description is given in which the lighting periods of the light sources are set to 30 milliseconds, but setting of lighting periods is not particularly limited thereto. The information processing apparatus 102 can set lighting periods of the light sources to individual values or the same value.

Note that, in consumer cameras, it is generally impossible to freely set the pulse width of the sync signal, that is, a period during which the sync signal is on. In some consumer cameras, for example, the pulse width of the sync signal changes depending on a shutter speed setting value. For this reason, in a case where a consumer camera is used as the image capture apparatus 103 and the sync signal is used as a lighting signal of a light source without any change, there have been cases where lighting periods of light sources cannot be freely set.

In addition, for example, there are cases where a captured image is too bright, resulting in the occurrence of blown-out highlights. Conversely, there are cases where a captured image is too dark, resulting in the occurrence of blocked up shadows. In those cases, by adjusting the lighting periods of light sources, blown-out highlights and blocked up shadows can be reduced. However, in a case where, as described above, the lighting periods of light sources cannot be freely set if the sync signal is used as a lighting signal of a light source without any change, it is difficult to correct blown-out highlights or blocked up shadows through such adjustment of lighting periods of light sources. On the other hand, by adopting the configuration according to the present embodiment, it is possible to set the pulse width of each lighting signal, that is to say, a period during which lighting of the light source continues. Accordingly, it is possible to individually adjust the lighting periods of the respective light sources, and also to correct blown-out highlights or blocked up shadows.

In addition, for example, in the multi-light illumination device, the light emission amounts of some light sources may decrease over time. Even in such a case, by adopting the configuration according to the present embodiment, the influence of changes over time can be reduced by individually adjusting the lighting periods of the respective light sources.

In addition, for example, due to accumulation of delays in processes, image capturing timings may be misaligned with lighting timings of light sources. In that case, by setting a lighting time longer than the shutter speed of the image capture apparatus, that is to say the exposure period, it is possible to reduce the influence of timing misalignment caused by the accumulation of delays in processes. When the shutter speed is 1/60 seconds, for example, each lighting period is set to 30 milliseconds, which is approximately double the shutter speed. In addition, depending on an image capture apparatus, the timing of a start of exposure may be delayed relative to the timing when the sync signal is output. In that case, it suffices for a predetermined light emission delay time to be set for each lighting signal such that the lighting timing of the light source is delayed. The light emission delay time according to the present embodiment is a delay time that is provided before light emission control, and is set for input or output of a lighting signal.

Here, the description returns to the flow of the processing that is performed by the image capture control unit 302 (FIG. 4B). In processing after step S410, the image capture control unit 302 captures images of the surface of the target object while turning on a plurality of light sources (here, L1 to L40 shown in FIG. 2A) that form the multi-light illumination device, simultaneously or individually for a predetermined time in a predetermined order. Accordingly, a plurality of captured images in which the illumination direction differs are obtained.

Steps S411 to S420 represent loop processing that is repeatedly performed. Here, in step S420, determination on whether or not to end the loop processing is performed. The image capture control unit 302 executes steps S411 to S418 in any iteration of this loop processing (constantly).

In step S411, the image capture control unit 302 determines whether or not the sync signal has changed from off to on. As described above, in the present embodiment, the sync signal changes from off to on at the timing when a still image was started to be captured. If it is determined as YES in step S411, the procedure advances to step S412, otherwise the procedure advances to step S418.

Note that, in order to determine whether or not the sync signal has changed from off to on, for example, in step S411, the image capture control unit 302 obtains and stores the potential of X_in of the control unit 114. The image capture control unit 302 then compares the potential of X_in stored in the past with the current potential of X_in, when step S411 is executed in the next loop processing. At this time, if the potential of X_in stored in the past is a high potential and the current potential of X_in is a low potential, it is determined that the sync signal has changed from off to on. Note that a change in the sync signal may be determined using an interrupt function of the control unit 114. In that case, step S411 is not executed in the flow in FIG. 4B, but, instead, an interrupt is performed when the potential of X_in changes from a low potential to a high potential. Then, when an interrupt is performed, processing of steps S412 to S417 is executed.

By constantly executing step S411, the image capture control unit 302 constantly monitors whether or not the sync signal has been input from the image capture unit 303. Next, the image capture control unit 302 executes the processing of steps S412 to S417 at the timing when the sync signal is input. By performing such processing, it is possible to switch each lighting signal from off to on, and switch the release signal from on to off based on the count of the sync signal.

In step S412, the count unit 309 of the image capture control unit 302 increments the count of the sync signal. The count of the sync signal corresponds to the count of the number of still images captured in continuous image capturing. FIG. 5B shows a situation where the count of the sync signal changes from 0 to 9. Note that, hereinafter, this count of the sync signal may be simply referred to as “count”.

In step S413, the count unit 309 determines whether or not the count of the sync signal has reached a specified count. In the present embodiment, as shown in FIG. 5A, nine captured images are obtained in correspondence with the count of 1 to 9. For this reason, the specified count that is used in step S413 is 9. If it is determined as YES in step S413, the procedure advances to step S414, otherwise the procedure advances to step S415.

In step S414, the count unit 309 sends an image capture stop instruction to the release signal output unit 307, and advances the procedure to step S415. Upon receiving the image capture stop instruction, the release signal output unit 307 switches OFF the release signal. As shown in FIG. 5B, for example, at time t9, at the timing when the sync signal changes from off to on, the sync signal count changes to 9. At this timing, the count unit 309 sends the image capture stop instruction to the release signal output unit 307. Next, the release signal output unit 307 switches OFF the release signal in accordance with the image capture stop instruction. At this timing, the image capture unit 303 stops continuous image capturing.

In a case where a consumer camera is used as the image capture apparatus 103, intervals between timings at which respective still images are captured in continuous image capturing may become irregular as shown in FIG. 5B. Assuming that intervals between timings at which respective still images are captured in continuous image capturing are equal, continuous image capturing can be stopped when a predetermined number of images are captured, by adjusting a period during which the release signal is on. In the present embodiment, for example, the number of captured images per second during continuous image capturing is assumed to be 30, and a continuous image capture mode corresponding to this assumption is set in the image capture apparatus 103. In this case, assuming that intervals between timings at which respective still images are captured are equal, it is possible to calculate a period during which the release signal needs to be on, by multiplying 1/30 seconds by a desired number of captured images. In a case where the desired number of captured images is nine, for example, a period during which the release signal needs to be on is 3/10 seconds. However, in actuality, intervals between timings when respective still images are captured are irregular as shown in FIG. 5B, and thus the number of captured images may be 8 sometimes or 10 at other times.

In this manner, in the case where an image capture apparatus with which intervals between image capture timings in continuous image capturing are irregular is used, it has been impossible to stop continuous image capturing at a specified time when a predetermined number of images are captured. On the other hand, the image capture control unit 302 according to the present embodiment stops output of the release signal based on the number of times the sync signal was obtained (particularly, when the number of times the sync signal was obtained exceeds a predetermined number of times). For this reason, even in the case where an image capture apparatus (for example, a consumer camera) with which intervals between image capture timings in continuous image capturing are irregular is used, continuous image capturing can be stopped at a specified time when a predetermined number of images are captured. Particularly, in a case where appearance inspection of an industrial product is performed based on a plurality of images obtained through continuous image capturing as in the present embodiment, there are cases where an accurate inspection result cannot be obtained if the number of captured images changes. In addition, when the number of captured images increases and exceeds a predetermined number of images, a time period requested for appearance inspection may be exceeded due to an increase in the data transfer time. For this reason, in particular, in appearance inspection, it is important to be able to stop continuous image capturing when a predetermined number of images are captured. Note that, a configuration may be adopted in which, in a case where an image capture apparatus with which intervals between image capture timings in continuous image capturing are equal is used, output of the release signal is stopped based on a time estimated based on the intervals between image capture timings.

Here, step S416 will be described before describing step S415. In step S416, the lighting signal output unit 310 switches on the lighting signal corresponding to the count to turn on the light source. At this time, in a state where a light source that was turned on in accordance with the previous count is on, a captured image with a desired illumination direction cannot be obtained. In a case where the lighting periods shown in FIG. 5A are set longer than intervals of continuous image capturing performed by the image capture apparatus 103 due to a user setting mistake, for example, a light source that was turned on in accordance with the previous count is still on. In a case where, for example, the number of captured images per second during continuous image capturing is about 30, intervals of continuous image capturing change each time image capturing is performed, but are about 1/30 seconds. At this time, if a value that is larger than 1/30 seconds is set as a lighting period setting value, both a light source previously turned on and a light source subsequently turned on are on at the same time. In view of this, before step S416 is executed, the lighting signal output unit 310 switches OFF all of the lighting signals in step S415. Accordingly, all of the light sources of the illumination unit 305 are turned off. That is to say, the lighting signal output unit 310 turns off the light source that was turned on in the previous loop, before starting to turn on a light source in accordance with a new count. Here, the lighting signal output unit 310 can perform lighting control of light sources such that the continuous lighting periods of the light sources do not exceed the intervals between a plurality of number of times of image capturing. In this manner, by controlling on and off of the light sources such that the time intervals between a plurality of number of times of image capturing in continuous image capturing are not exceeded, it is possible to prevent influence of a setting mistake.

After executing step S415, the lighting signal output unit 310 switches on the lighting signal corresponding to the count in step S416. In a case where the settings shown in FIG. 5A have been performed, for example, the lighting signal output unit 310 switches on the lighting signal L_out_1 when the count is 1, switches on the lighting signal L_out_2 when the count is 2, and switches on the lighting signal L_out_33 when the count is 9. Next, the illumination unit 305 turns on the light source corresponding to the lighting signal. The illumination unit 305 turns on the light source L1 when the count is 1, turns on the light source L2 when the count is 2, and turns on the light sources L33 to L40 simultaneously when the count is 9, for example. That is to say, the illumination unit 305 individually turns on the eight light sources L1 to L8 sequentially when the count is in a range from 1 to 8, and turns on the eight light sources L33 to L40 simultaneously when the count is 9.

Note that the microcomputer of the control unit 114 is operating at a clock frequency of several tens of megahertz. For this reason, the processing of steps S412 to S415 is completed on the order of microseconds. That is to say, a time period from a timing when the sync signal changed from off to on until when step S416 is executed is on the order of microseconds. On the other hand, an exposure period of the image capture apparatus 103 depends on shutter speed setting, but is in a range of several milliseconds to several tens of milliseconds. For this reason, an image capturing start timing when the sync signal is output and a lighting timing of a light source can be regarded as practically coinciding with each other.

Next, in step S417, the lighting signal output unit 310 starts measuring the elapsed time from when the lighting signal was switched on in step S416, in order to continue a state where the lighting signal is on for a predetermined period. The lighting signal output unit 310 can measure the elapsed time by the control unit 114 of the information processing apparatus 102 counting a clock for operating the microcomputer, for example. Here, the elapsed time is measured for each lighting signal. Note that a period during which each lighting signal is on corresponds to the lighting period of the light source, and is set by the user. In the example in FIG. 5A, all of the lighting signals (L_out_1 to L_out_8 and L_out_33) are set to a uniform lighting period (30 milliseconds). However, the lighting periods of the light sources do not need to be uniform, and, for example, a lighting period may be controlled for each light source, and lighting periods of the same light source may be controlled for respective lighting timings. A lighting period for each lighting signal is set as a parameter in program code that runs on the control unit 114 of the information processing apparatus 102. Note that the same applies to the above-described light emission delay time for each lighting signal. When step S417 ends, the procedure advances to step S418.

In step S418, the lighting signal output unit 310 determines whether or not there is a lighting signal for which the elapsed time of the ON state has reached a predetermined time. If it is determined as YES in step S418, the procedure advances to step S419, otherwise the procedure advances to step S420.

By constantly executing step S418, the image capture control unit 302 constantly monitors the elapsed time from when each lighting signal was switched from off to on. Next, at the timepoint when the elapsed time that is being monitored reaches a predetermined elapsed time set for each lighting signal, the image capture control unit 302 switches OFF the corresponding lighting signal, in step S419.

In step S419, the lighting signal output unit 310 switches OFF the lighting signal for which it is determined in step S418 that the elapsed time of the ON state has reached the predetermined time. By performing such processing, a period during which each lighting signal is on is controlled. FIG. 5B shows a situation where all of the lighting signals (L_out_1 to L_out_8 and L_out_33) are on for a period of 30 milliseconds that is a uniform lighting period set in FIG. 5A.

In step S420, the image capture control unit 302 determines whether or not the release signal is off and all of the lighting signals are off. If it is determined as YES in step S420, the processing in FIG. 4C ends, otherwise the procedure returns to step S411.

### Effects of Present Embodiment

By adopting such a configuration, even in a case where an image capture apparatus with which a release time lag changes each time image capturing is performed is used, it is possible to perform lighting control of light sources in accordance with a sync signal being obtained, the sync signal having been output at an image capture timing by the image capture apparatus. Therefore, it is possible to align lighting timings of light sources with image capture timings.

In addition, the lighting signal output unit 310 measures the elapsed times from when lighting of the respective lighting signals started, and can thus individually control the lighting periods of the light sources. For this reason, even in a case where the light emission amounts of some of the light sources decrease due to time-related changes in a device, the influence of time-related changes can be reduced by individually adjusting the lighting periods of the light sources.

In addition, in the image processing system 1, measure for outputting an image capture instruction signal to the image capture apparatus 103, measure for obtaining an image capture timing signal from the image capture apparatus 103, and measure for performing lighting control of light sources can be operated within the same apparatus (particularly, the information processing apparatus 102). In addition, image processing, processing for outputting an image capture start signal, and processing of post-processes that is performed based on an inspection result, which have been described in the present embodiment, may be executed by an apparatus (CPU) different from the information processing apparatus 102 that controls lighting of light sources and image capturing. By adopting such a configuration, it is possible to reduce processing delays of program code that is being executed by the information processing apparatus 102. Accordingly, it is possible to more accurately align the lighting timings of light sources with image capture timings.

In addition, even in a case where an image capture apparatus with which intervals between image capture timings during continuous image capturing are irregular is used, output of the release signal is stopped based on the number of times the sync signal was obtained, and thus continuous image capturing can be stopped when a predetermined number of images are captured. Accordingly, in a case where appearance inspection of an industrial product is performed based on a plurality of images obtained through continuous image capturing, it is possible to obtain a more accurate inspection result.

### Modification

Note that, there are cases where, even if output of a release signal is stopped based on the number of times a sync signal was obtained, continuous image capturing stops with a delay due to a delay in processing and the number of captured images exceeds a predetermined number of images, depending on the model of an image capture apparatus. In view of this, at the timepoint when the number of captured images reaches a specified number of images before the predetermined number of images, the information processing apparatus 102 prepares to switch off the release signal. Specifically, the information processing apparatus 102 starts measuring the elapsed time at the timepoint when the specified number of images (N images) before the predetermined number of images is reached, and switches OFF the release signal at the timing when an estimated time has passed at which the number of images captured in continuous image capturing reaches the predetermined number of images. Note that the estimated time at which the number of images captured in continuous image capturing reaches the predetermined number of images is estimated based on the number of captured images per second during continuous image capturing.

In the first embodiment, the number of captured images per second during continuous image capturing is assumed to be 30, and a continuous image capture mode corresponding to this assumption is set in the image capture apparatus 103. In this case, an image capture time per image is about 1/30 seconds. For this reason, in a case of starting to prepare to switch off the release signal when one image before the predetermined number of images is reached, the information processing apparatus 102 switches off the release signal at the timing when 1/30 seconds has elapsed from when the number of captured images reaches one image before the predetermined number of images. Similarly, in a case of starting to prepare to switch off the release signal when three images before the predetermined number of images is reached, the information processing apparatus 102 switches off the release signal at the timing when 1/10 seconds has elapsed from when the number of captured images reaches three image before the predetermined number of images.

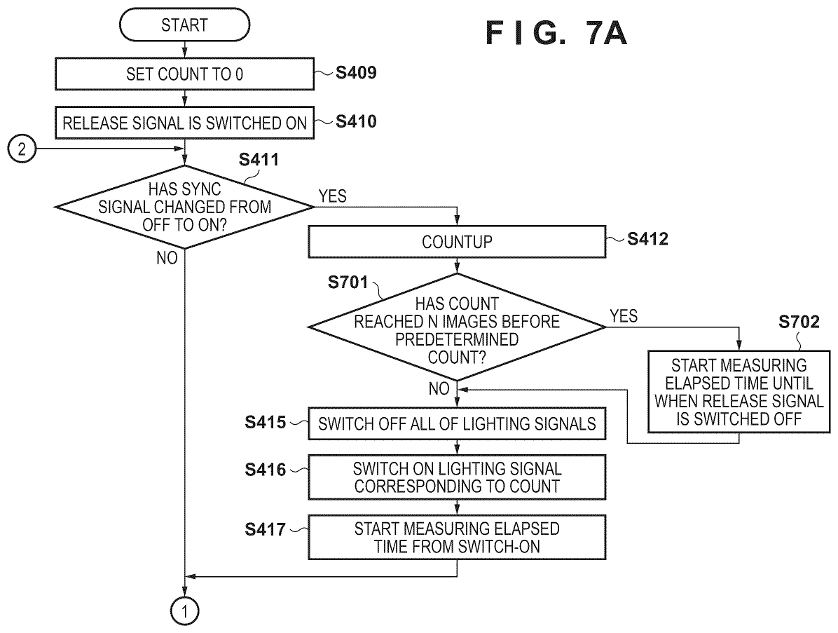

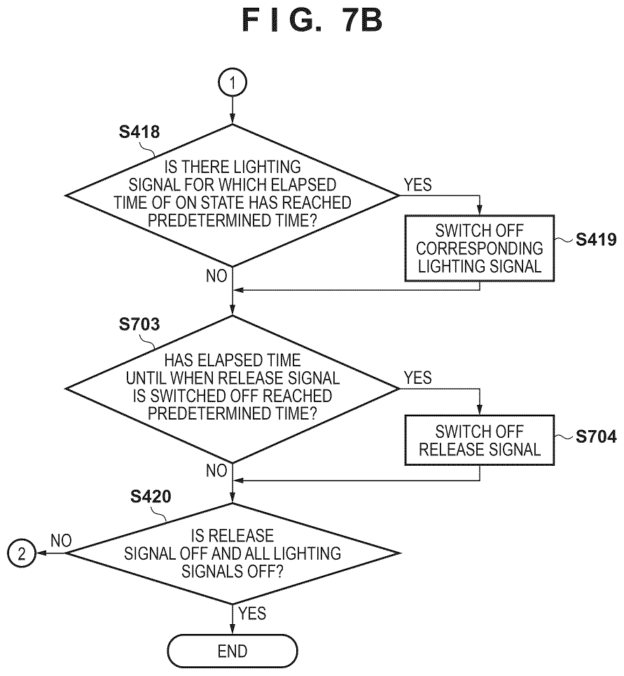

FIGS. 7A and 7B are a flowchart showing an example of information processing that is performed by the information processing apparatus 102 in such a case of starting to prepare to switch off the release signal when the specified number of images before the predetermined number of images is reached. The processing shown in FIGS. 7A and 7B are performed similarly to FIG. 4B except that steps S701 and S702 are performed in place of steps S413 and S414, and steps S703 and S704 are added as processing that is subsequent to step S418 or S419, and thus an overlapping description is omitted.

In step S701, the count unit 309 determines whether or not the count has reached a specified number of images (hereinafter, N) of a specified count. If it is determined as YES in step S701, the procedure advances to step S702, otherwise the procedure advances to step S415.

In step S702, the count unit 309 starts measuring the elapsed time until when the release signal is switched off. This elapsed time is constantly monitored in step S703. Specifically, in step S703, the count unit 309 determines whether or not the elapsed time until when the release signal is switched off has reached a predetermined time. Step S703 represents processing that is performed if it is determined as NO in step S418, or when step S419 is complete. Here, the predetermined time is an estimated time at which the number of images captured in continuous image capturing will reach the predetermined number of images. If it is determined as YES in step S703, the procedure advances to step S704, otherwise the procedure advances to step S420.

In step S704, the count unit 309 sends an image capture stop instruction to the release signal output unit 307. Upon receiving the image capture stop instruction, the release signal output unit 307 switches OFF the release signal. Accordingly, the image capture unit 303 stops continuous image capturing. As described above, by adopting the configuration shown in FIGS. 7A and 7B are, even in a case where an image capture apparatus with which stop of continuous image capturing delays due to a delay in processing is used, continuous image capturing can be stopped when the predetermined number of images are captured.

In addition, in a case where the light emission amounts of 32 light sources L1 to L32 are the same, captured images obtained by individually turning on the light sources L1 to L32 have different brightnesses depending on the zenith angles of the light sources. This is because the larger the zenith angle is, the larger the angle between the normal line of the surface of the target object and the light beam becomes, resulting in smaller perpendicular illuminance on the surface of the target object. In view of this, light emission amounts are individually set for respective light sources by changing lighting periods or duty ratios of PWM signals thereof. Specifically, the information processing apparatus 102 sets a larger light emission amount for a light source for which the angle between the normal line of the surface of the target object and the light beam is larger (light source having a larger zenith angle). Accordingly, the brightnesses of captured images can be made uniform regardless of the zenith angles of the light sources. In addition, the light emission amounts of a plurality of light sources at the same zenith angle may vary depending on an azimuth angle. Also in that case, by individually setting light emission amounts of respective light sources, it is possible to reduce variation in a light emission amount that depend on an azimuth angle. In this manner, the information processing apparatus 102 can control light emission intensity of lighting of each light source among a plurality of light sources.

In addition, in a case where a plurality of light sources are individually turned on, a light emission color may vary depending on a light source. In that case, by adjusting a light emission color for each light source, it is possible to reduce the influence of variation in light emission color. In this manner, the information processing apparatus 102 can control a light emission color of lighting of each light source among a plurality of light sources.

In addition, in the first embodiment, a single lighting signal (L_out_33) is used when eight light sources L33 to L40 are simultaneously turned on, but a configuration may also be adopted in which a plurality of light sources are simultaneously turned on by simultaneously switching on a plurality of lighting signals. In a case where eight light sources of L1 to L8 are simultaneously turned on, for example, L_out_1 to L_out_8 are simultaneously switched on. At this time, the information processing apparatus may individually set lighting periods for the respective lighting signals L_out_1 to L_out_8 as described above. A light emission amount may vary for each of the light sources L1 to L8, for example, and, in that case, when these are simultaneously turned on, brightnesses of captured images become uneven. At this time, by individually setting lighting periods of L1 to L8, it is possible to reduce unevenness in brightnesses of captured images. It is sufficient that lighting periods of L1 to L8 are individually adjusted based on captured images of a surface with uniform reflective properties, for example. Alternatively, when PWM waveforms are output as lighting signals, light emission amounts may be individually controlled by adjusting duty ratios for the respective lighting signals.

In addition, the same light source may be turned on a plurality of number of times in accordance with the sync signal. A configuration may be adopted in which, for example, two captured images in which the illumination direction is the same are obtained by switching on L_out_1 in accordance with the count is 1 and 2, to turn on the light source L1 twice. In this case, the information processing apparatus 102 may average these two captured images to reduce noise in the obtained image.

In addition, when turning on the same light source a plurality of number of times, the information processing apparatus 102 may control the light emission intensity of lighting for each lighting timing. In a case where L_out_1 is switched on when the count is both 1 and 2 to turn on the light source L1 twice, for example, the light emission intensity may be changed by changing the lighting period or the duty ratio of the PWM signal when the count is 1 and 2. Accordingly, it is possible to obtain a plurality of captured images in which the illumination direction is the same but the brightness is different (and combine those images into an HDR image). It is possible to obtains a plurality of captured images in which the illumination direction is the same but the brightness is different, and generate a multi-band image by combining those images.

In addition, similarly, when the same light source is turned on a plurality of number of times, the information processing apparatus 102 may control the light emission color of lighting for each lighting timing of the light source. In addition, similarly, when the same light source is turned on a plurality of number of times, the lighting period may be controlled for each lighting timing of the light source.

In addition, in the present embodiment, a description has been given in which a target object is a motionless object, but the target object is not particularly limited thereto, and may be moving, for example. In a case where continuous image capturing of a rotating target object is performed, for example, it is possible to obtain a plurality of captured images in which the rotation angle is different. In that case, the information processing apparatus 102 may constantly keep the light sources on during continuous image capturing, and turn off light sources at the timing when the number of times the sync signal was obtained reaches a predetermined number of times. As described above, in a case where the same light source is turned on a plurality of number of times, the illumination apparatus 108 may be an apparatus that includes only one light source. That is to say, the illumination apparatus 108 is not limited to multiple light sources such as those described above.

In addition, a lighting pattern when light sources are sequentially turned on in accordance with the sync signal may be switched based on user setting, a type of target object, or the like. When appearance inspection of an industrial product is performed as in the first embodiment, for example, the information processing apparatus 102 can switch the lighting pattern in accordance with a type of target object, a requested takt time, the number of target objects whose images are to be captured at the same time, or the like. When precise inspection is requested, when there is a margin in the takt time, when the number of target objects whose images are to be captured at the same time is large, or the like, for example, the information processing apparatus 102 may individually turn on 32 light sources L1 to L32 sequentially, and then turn on L33 to L40 at the same time. On the other hand, when precise inspection is not requested, when there is no margin in the takt time, the number of target objects whose images are to be captured at the same time is small, or the like, the information processing apparatus 102 may individually turn on the eight light sources L1 to L8 sequentially. In this manner, by switching the lighting pattern in accordance with a situation, image capturing can be performed based on a user's request.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-005558, filed Jan. 17, 2024, which is hereby incorporated by reference herein in its entirety.

What is claimed is:

1. An information processing apparatus comprising:
an outputting unit configured to output an image capture instruction signal instructing that image capturing is performed, to an image capture apparatus;
an obtaining unit configured to obtain an image capture timing signal indicating a timing for performing image capturing, from the image capture apparatus; and
a control unit configured to perform lighting control of a light source in accordance with the image capture timing signal being obtained.

2. The information processing apparatus according to claim 1, further comprising:
a setting unit configured to set a lighting period of the light source,
wherein the control unit performs lighting control of the light source based on the set lighting period.

3. The information processing apparatus according to claim 1,
wherein the control unit performs lighting control of the light source to keep the light source on for a longer time than an exposure period of the image capturing.

4. The information processing apparatus according to claim 1,
wherein the outputting unit outputs the image capture instruction signal to the image capture apparatus by controlling a current-carrying state of a terminal that transmits the image capture instruction signal.

5. The information processing apparatus according to claim 1,
wherein the obtaining unit obtains the image capture timing signal by controlling a current-carrying state of a terminal that receives the image capture timing signal.

6. The information processing apparatus according to claim 1,
wherein the outputting unit, the obtaining unit, and the control unit operate in the same apparatus.

7. The information processing apparatus according to claim 1,
wherein the outputting unit outputs a continuous image capture instruction signal instructing that image capturing is performed a plurality of number of times, as the image capture instruction signal, and
the obtaining unit obtains, from the image capture apparatus, the image capture timing signal each time image capturing that is performed a plurality of number of times is performed.

8. The information processing apparatus according to claim 7,
wherein the control unit performs lighting control of the light source such that a continuous lighting period of the light source does not exceed an interval of the image capturing that is performed a plurality of number of times.

9. The information processing apparatus according to claim 7,
wherein the outputting unit outputs the image capture instruction signal to the image capture apparatus by controlling a current-carrying state of a terminal that transmits the continuous image capture instruction signal.

10. The information processing apparatus according to claim 7,
wherein the outputting unit further outputs a signal for stopping the image capturing to the image capture apparatus in accordance with the number of times the obtaining unit received the image capture timing signal.

11. The information processing apparatus according to claim 10,
wherein, in a case where the number of times the obtaining unit obtained the image capture timing signal exceeds a predetermined number of times, the outputting unit outputs the signal for stopping the image capturing.

12. The information processing apparatus according to claim 10,
wherein the outputting unit outputs the signal for stopping the image capturing at a timing when a predetermined time has elapsed from a timepoint when the number of times the obtaining unit received the image capture timing signal has exceeded the predetermined number of times.

13. The information processing apparatus according to claim 1,
wherein the control unit performs control so as to turn on a plurality of light sources in a predetermined order, and
the outputting unit outputs the image capture instruction signal instructing that the image capture apparatus performs image capturing a plurality of number of times under control relating to the order in which the light sources are turned on.

14. The information processing apparatus according to claim 13,
wherein the control unit turns on light sources in a first group included in the plurality of light sources at different timings, and turns on light sources in a second group included in the plurality of light source at the same time.

15. The information processing apparatus according to claim 13,
wherein the control unit controls a lighting period of each light source included in the plurality of light sources.

16. The information processing apparatus according to claim 13,
wherein the control unit controls light emission intensity of lighting of each light source included in the plurality of light sources.

17. The information processing apparatus according to claim 13,
wherein the control unit controls a light emission color of lighting of each light source included in the plurality of light sources.

18. The information processing apparatus according to claim 13,
wherein the control unit controls a delay time in light emission of each light source included in the plurality of light sources.

19. The information processing apparatus according to claim 13, further comprising
a setting unit configured to set the predetermined order of lighting of the plurality of light sources.

20. The information processing apparatus according to claim 13, further comprising
a first inspection unit configured to inspect a color or shape of a subject based on a plurality of images captured through the image capturing that is performed a plurality of number of times.

21. The information processing apparatus according to claim 13, further comprising
a second inspection unit configured to inspect gloss of a subject based on a plurality of images captured through the image capturing that is performed a plurality of number of times.

22. The information processing apparatus according to claim 13,
wherein the control unit further control a light source to be turned on from among the plurality of light sources, in accordance with the number of times the obtaining unit obtained the image capture timing signal.

23. The information processing apparatus according to claim 22,
wherein the control unit controls output of a signal from a terminal corresponding to light source to be turned on from among the plurality of light sources, thereby performing lighting control of the light source.

24. The information processing apparatus according to claim 1,
wherein the control unit performs control such that the same light source is turned on a plurality of number of times, and
the outputting unit outputs the image capture instruction signal instructing that the image capture apparatus performs image capturing a plurality of number of times in accordance with control of lighting of the same light source that is performed a plurality of number of times.

25. The information processing apparatus according to claim 24,
wherein the control unit controls a plurality of number of times of lighting of the same light source so as to control a lighting period for each lighting timing.

26. The information processing apparatus according to claim 24,
wherein the control unit controls a plurality of number of times of lighting of the same light source so as to control light emission intensity of lighting for each lighting timing.

27. The information processing apparatus according to claim 24,
wherein the control unit performs lighting control of the same light source that is performed a plurality of number of times so as to control a light emission color of lighting for each lighting timing.

28. An information processing method comprising:
outputting an image capture instruction signal instructing that image capturing is performed, to an image capture apparatus;
obtaining an image capture timing signal indicating a timing for performing image capturing, from the image capture apparatus; and
performing lighting control of a light source in accordance with the image capture timing signal being obtained.

29. A non-transitory computer-readable storage medium storing a program which, when executed by a computer comprising a processor and memory, causes the computer to:
output an image capture instruction signal instructing that image capturing is performed, to an image capture apparatus;
obtain an image capture timing signal indicating a timing for performing image capturing, from the image capture apparatus; and
perform lighting control of a light source in accordance with the image capture timing signal being obtained.
